(19) United States
(12) Patent Application Publication
(10) Pub. No.: US 2023/0343240 A1
(43) Pub. Date: Oct. 26, 2023

(54) TRAINING AND SUGGESTION SYSTEMS AND METHODS FOR IMPROVED DRIVING

(71) Applicant: TOYOTA RESEARCH INSTITUTE, INC., LOS ALTOS, CA (US)

(72) Inventors: JAIME S. CAMHI, Los Gatos, CA (US); MANUEL LUDWIG KUEHNER, Mountain View, CA (US); HIROSHI YASUDA, San Francisco, CA (US)

(73) Assignees: TOYOTA RESEARCH INSTITUTE, INC., LOS ALTOS, CA (US); TOYOTA JIDOSHA KABUSHIKI KAISHA, TOYOTA-SHI (JP)

(21) Appl. No.: 17/724,768

(22) Filed: Apr. 20, 2022

(51) Int. Cl. G09B 19/16; G07C 5/02

(52) U.S. Cl. CPC G09B 19/167; G07C 5/02

(57) ABSTRACT

Systems and methods are provided for training and suggestion frameworks to improve driver operation of a vehicle. A driver may perform certain maneuvers frequently. Pairing these maneuvers with assigned stimuli may form an association in the driver's mind between the maneuver and the stimuli. A driving scenario may arise in which it would be safer, compliant, more efficient, or more effective for a driver to perform a certain maneuver. If a driver has formed a strong mental association between a maneuver and assigned stimuli, the assigned stimuli may be presented to prompt the driver to perform the maneuver. A driver may still retain ultimate control of a vehicle and may choose not to perform the maneuver.

### TECHNICAL FIELD

The present disclosure relates generally to systems and methods for suggesting and/or encouraging improved driving, and in particular, some implementations may relate to a two-phase driver training and suggestion framework.

### DESCRIPTION OF RELATED ART

Vehicles may include many different types of sensors configured to detect vehicle characteristics as well as data about the surrounding environment. In some vehicles, sensors communicate with vehicle systems that assist with driving tasks. Some systems are configured to intervene and override driver control if certain scenarios arise. For example, some systems apply emergency braking based on sensor data. Emergency braking could be applied, for example, if an obstacle was detected in the path of the vehicle or if external sensors detected icy conditions on the road. Other situations are also possible.

However, intervening systems may also override driver control and perform maneuvers in undesirable situations. For example, a false positive may occur if an intervening system instructs a driver to brake because sensors were inadvertently triggered even though there is no obstacle in the road or other reason to brake. That is, sensors may erroneously detect some object or event, and an intervening system may, in response to sensor data, perform a maneuver that was not warranted. In extreme cases, the maneuvers may even be inappropriate or dangerous. In other situations an intervening system may not perform a maneuver at all due to a lack of certainty regarding whether the maneuver is appropriate. Accordingly, many drivers remain skeptical about the safety and accuracy of intervening systems and may prefer to drive a vehicle over which they may retain complete control. Drivers may also disable or turn off intervening systems if they do not trust the system.

Though intervening systems pose drawbacks, sensor data may still be valuable to drivers and may still provide a good indication of potential risks and relevant driving scenarios. If a driver disables their intervening system, a driver may not receive useful information about driving conditions. Therefore, a system that makes use of this information but still leaves ultimate control of a vehicle with a driver may be desirable.

Additionally, driver judgment is not infallible. Drivers may easily become distracted or choose to engage in risky or dangerous driving behavior. Drivers may ignore relevant information such as road conditions, traffic, navigation instructions, speed limits, and other important information while driving. Therefore, a system which encourages drivers to exercise better judgment and perform more appropriate driving maneuvers, while still leaving ultimate control of a vehicle with a driver may also be desirable.

### BRIEF SUMMARY OF THE DISCLOSURE

According to various embodiments of the disclosed technology a two part framework may encourage safe, accurate, efficient and/or compliant driving. The two part framework may include a training phase and a suggestion phase. In an embodiment, the training phase may be implemented using a training system. In an embodiment, the training system may include a sensor array. The sensor array may include sensors configured to detect vehicle maneuvers performed by a driver. A training system may also include a human-machine interface (“HMI”). The HMI may be configured to present stimuli to a driver. The training system may also include a training circuit. The training circuit may be communicably coupled to the sensor array and HMI. The training circuit may be configured to assign corresponding stimuli to a set of vehicle maneuvers, detect a vehicle maneuver of the set of vehicle maneuvers using the sensory array, and while the detected vehicle maneuver is occurring, present the assigned stimuli using the HMI.

In an embodiment of a training system, the stimuli may include visual stimuli. In an embodiment, the visual stimuli may include visual stimuli delivered on a heads up display (“HUD”). In an embodiment, the stimuli may include visual stimuli delivered on a dashboard. In an embodiment, the stimuli may include visual stimuli delivered on a-pillars. In an embodiment, the stimuli may include visual stimuli delivered on a steering wheel. In an embodiment, the stimuli may include tactile stimuli. In an embodiment, the stimuli may include tactile stimuli delivered through a driver's seat. In an embodiment, the stimuli may include tactile stimuli delivered through a steering wheel. In an embodiment, the stimuli may include tactile stimuli delivered through pedals.

As discussed above, the two part framework may include a training phase and a suggestion phase. In an embodiment, the suggestion phase may be implemented using a suggestion system. A suggestion system may include a sensory array. The sensory array may include sensors configured to detect driving scenarios. The suggestion system may also include an HMI configured to present stimuli to a driver. The suggestion system may also include a suggestion circuit communicably coupled to the sensory array and HMI. The suggestion circuit may be configured to detect a driving scenario using the sensor array, identify a desired maneuver corresponding to the detected driving scenario, receive an indication of assigned stimuli corresponding to the desired maneuver, and present the assigned stimuli using the HMI to suggest the desired maneuver to a driver.

In an embodiment of a suggestion system, the driving scenario may be a scenario warranting a communication action. In an embodiment of a suggestion system, the driving scenario may be a scenario warranting a longitudinal control action. In an embodiment of a suggestion system, the driving scenario may be a scenario warranting a lateral control action. In an embodiment of a suggestion system, the driving scenario may be a risk scenario. In an embodiment of a suggestion system, the driving scenario may be a rule scenario. In an embodiment of a suggestion system, the driving scenario may be a navigation scenario.

An improved driving prompt method may include assigning stimuli to a set of vehicle maneuvers. The method may also include detecting initiation of a vehicle maneuver of the set of vehicle maneuvers. The method may also include presenting the stimuli corresponding to the detected maneuver while a driver continues to perform the detected maneuver. The method may also include repeating the detecting and presenting operations to create an association between the maneuver and the stimuli in the driver's mind. The method may also include detecting a current driving scenario for the area in which a driver is operating a vehicle. The method may also include identifying a desired vehicle maneuver warranted by the driving scenario for the area in which the driver is operating the vehicle. The method may also include receiving an indication of assigned stimuli corresponding to the desired vehicle maneuver. The method may also include resenting the corresponding stimuli to suggest the desired vehicle maneuver to the driver.

In an embodiment, an improved driving prompt method may also include detecting that the driver performed the suggested vehicle maneuver. The method may also include recording the fact that the driver performed the suggested maneuver. The method may also include storing data related to the vehicle's surroundings and the performed maneuver. In an embodiment, an improved driver prompt method may also include detecting that the driver did not perform the suggested vehicle maneuver. The method may also include recording the fact that the driver did not perform the suggested maneuver. The method may also include storing data related to the vehicle's surroundings and any maneuvers performed by the driver.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for activating a training phase in accordance with one embodiment of the systems and methods described herein.

FIG. 3 illustrates an example architecture for activating a suggestion phase in accordance with one embodiment of the systems and methods described herein.

FIG. 4 is a diagram showing an example of feedback systems in accordance with the systems and methods disclosed herein.

FIG. 5 is a flow diagram showing an example of a training method in accordance with the systems and methods disclosed herein.

FIG. 6 is a flow diagram showing an example of a suggestion method in accordance with the systems and methods disclosed herein.

FIG. 7 is a flow diagram showing an example of training and suggestion methods for communication actions in accordance with the systems and methods disclosed herein.

FIG. 8 is a flow diagram showing an example of training and suggestion methods for lateral control actions in accordance with the systems and methods disclosed herein.

FIG. 9 is a flow diagram showing an example of training and suggestion methods for longitudinal control actions in accordance with the systems and methods disclosed herein.

FIG. 10 is a flow diagram showing an example of training and suggestion methods for overtake actions in accordance with the systems and methods disclosed herein.

FIG. 11 is a flow diagram showing an example of training and suggestion methods for risk-based actions in accordance with the systems and methods disclosed herein.

FIG. 12 is a flow diagram showing an example of training and suggestion methods for rule-based actions in accordance with the systems and methods disclosed herein.

FIG. 13 is a flow diagram showing an example of training and suggestion methods for navigation actions in accordance with the systems and methods disclosed herein.

FIG. 14 is an example computing component that may be used to implement various features of embodiments described in the present disclosure.

The figures are not exhaustive and do not limit the present disclosure to the precise form disclosed.

### DETAILED DESCRIPTION

Embodiments of the systems and methods disclosed herein can provide improved mental modeling and execution of safe and compliant driving. Specifically, the systems and methods disclosed herein may include a two-phase framework, e.g., a driver training phase, and a suggestion phase.

A first phase of the framework may comprise the driver training phase. Systems and methods deployed during the driver training phase may be leveraged to associate vehicle maneuvers with stimuli. Prior to the training phase, the stimuli may be neutral. In other words, a driver may not associate the stimuli with a particular maneuver. During the training phase, the stimuli may be paired with a specific maneuver such that the driver may come to associate the stimuli with the maneuver. That is, the driver may perform the maneuvers while operating the vehicle under regular and/or routine conditions for the driver. In response to the performance of such maneuvers, certain stimuli are presented to the driver in order to train the driver to associate certain maneuvers with certain stimuli.

Systems and methods deployed during a second phase, i.e., the suggestion phase, may be leveraged to suggest maneuvers to a driver to enhance driving safety and/or compliance with applicable laws. At the outset of the suggestion phase, stimuli may be conditioned. In other words, a driver may have come to associate stimuli with a particular maneuver. The driver may have come to pair the stimuli and maneuver during the training phase.

The suggestion phase may follow the training phase. During the suggestion phase, it may be desirable for a driver to perform a particular maneuver to mitigate risk or to operate the vehicle in compliance with the law. The systems and methods disclosed herein do not provide for autonomous driving. The systems and methods herein do not provide for an automatic maneuver or a maneuver overriding a driver's choice. A driver remains in control of their vehicle at all times. However, because a driver has come to associate or pair stimuli with performing a maneuver, a driver may be more likely to perform a maneuver when the corresponding stimuli is presented.

As discussed above, a two-part framework may involve a training phase and a suggestion phase. During the training phase, stimuli assigned to particular maneuver may be presented after the driver performs the specific maneuver in order to create an association in the driver's mind between the maneuver and the stimuli. Then, during the suggestion phase stimuli assigned to a specific maneuver may be presented before the driver performs the maneuver to suggest the maneuver. In other words, during the suggestion phase, the stimuli serves as a prompt and/or trigger to encourage the driver to perform a maneuver. Therefore, during the suggestion phase, stimuli corresponding to a particular maneuver may be presented when that particular maneuver is desired to mitigate driving risk and/or bring vehicle operation into compliance with the law.

Unlike autonomous driving, a driver retains ultimate physical control of the vehicle even while the systems and methods described above are implemented. Though the mental association formed between the assigned stimuli and each respective maneuver may be powerful, a driver remains free to override any prompt or suggestion. The fact that a driver may override a prompt or suggestion may improve driver comfort in using the systems and methods described above. This may result in a higher implementation rate of these systems. Simultaneously, however, a mental association between a set of assigned stimuli and a maneuver may remain powerful. This may be especially true if a driver is repeatedly training and/or trained for a significant period of time to association stimuli with corresponding maneuvers. Therefore, even though a driver may have the physical ability to override a suggestion, a suggestion may remain a powerful trigger for a driver. A driver may then be more likely to implement a suggestion. This may be true even if a driver is distracted and/or under stress.

Because suggestions may be powerful, such a system or method may offer an effective tool to improve driver safety, accuracy, and compliance. The success rate of a suggestion-based system in terms of safety/compliance outcomes may be sufficient that such a system may serve as a viable alternative to autonomous driving systems and methods.

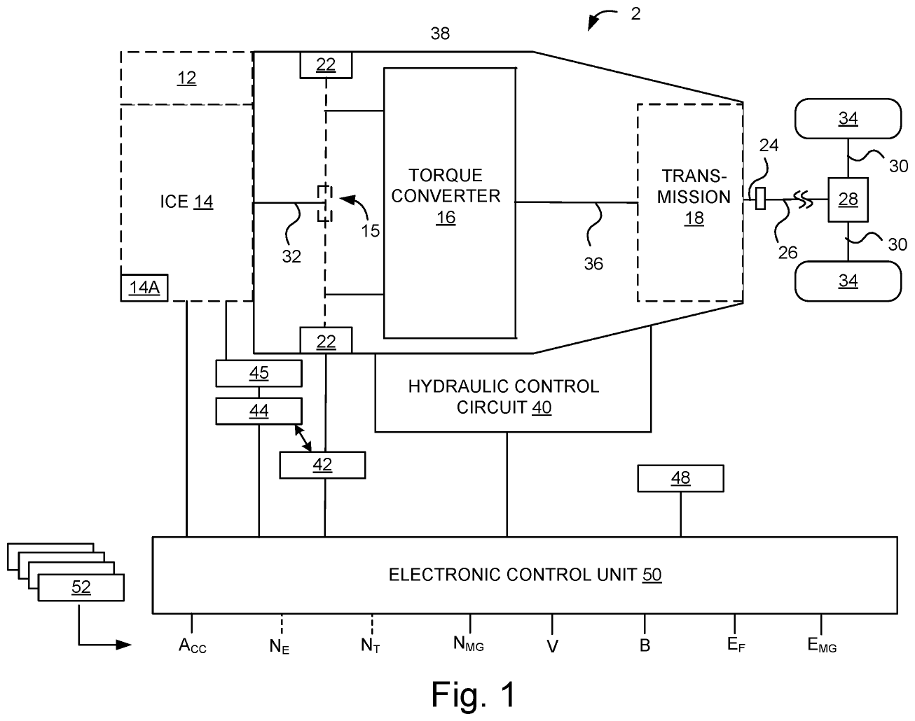

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the training and suggestion systems and methods for improved driving may be implemented in other types of vehicle including gasoline- or diesel-powered vehicles, fuel-cell vehicles, electric vehicles, or other vehicles.

FIG. 1 illustrates a drive system of a vehicle 102 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 102 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 102 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 102. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, NE, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 102 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc. Sensors may also detect external conditions such as, for example, detecting obstacles in the path of a vehicle. Sensors may also detect driver behavior or maneuvers. For example, a sensor may determine when a driver has applied the brakes, made a lane change, applied the parking brake, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as an example of a of vehicle systems with which embodiments of the disclosed technology may be implemented. One of ordinary skill in the art reading this description will understand how the disclosed embodiments can be implemented with vehicle platforms.

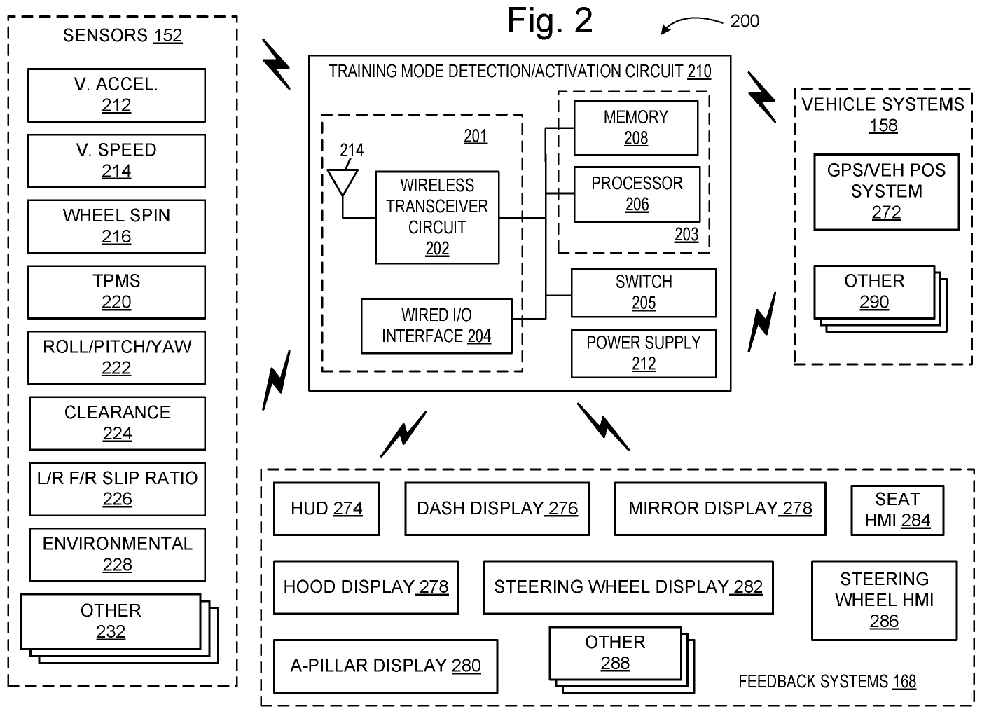

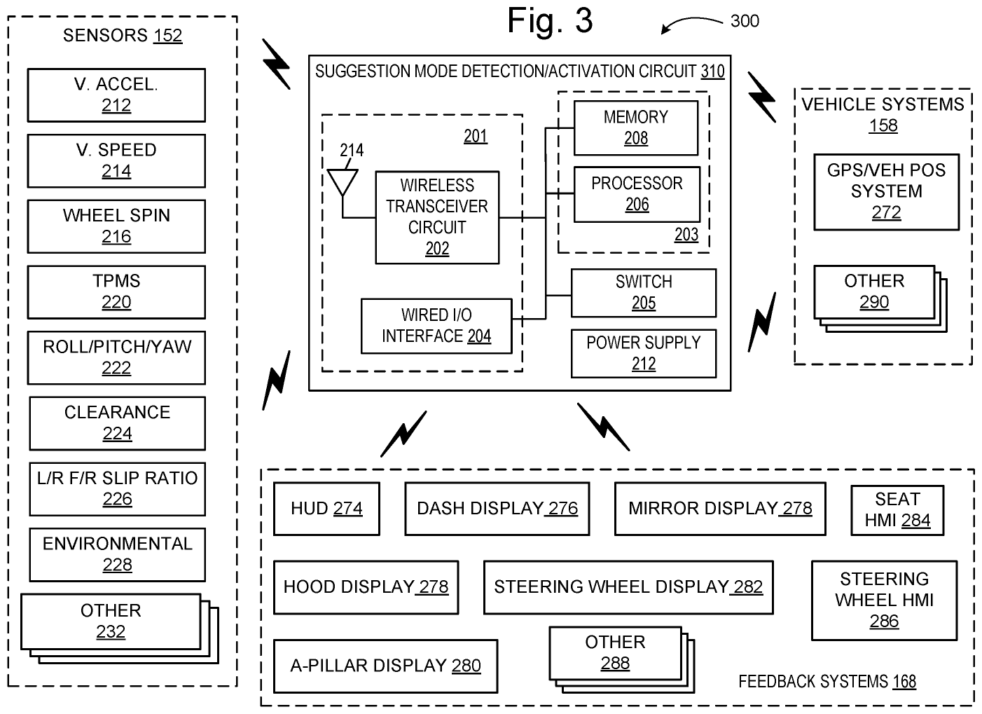

FIG. 2 illustrates an example architecture for activating a training mode in accordance with one embodiment of the systems and methods described herein. Referring now to FIG. 3, in this example, training mode activation system 200 includes an training mode detection/activation circuit 210, a plurality of sensors 152, a plurality of vehicle systems 158, and a plurality of feedback systems 168. Sensors 152, vehicle systems 158, and feedback systems 168 can communicate with training mode detection/activation circuit 210 via a wired or wireless communication interface. Although sensors 152, vehicle systems 158, and feedback systems 168 are depicted as communicating with training mode detection/activation circuit 210, they can also communicate with each other as well as with other systems. Training mode detection/activation circuit 210 can be implemented as an ECU or as part of an ECU such as, for example electronic control unit 50. In other embodiments, training mode detection/activation circuit 210 can be implemented independently of the ECU.

Training mode detection/activation circuit 210 in this example includes a communication circuit 201, a decision circuit (including a processor 206 and memory 208 in this example) and a power supply 212. Components of training mode detection/activation circuit 210 are illustrated as communicating with each other via a data bus, although other communication in interfaces can be included. Training mode detection/activation circuit 210 in this example also includes a manual switch 205 that can be operated by the user to manually select the training mode.

Processor 206 can include a GPU, CPU, microprocessor, or any other suitable processing system. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208, can be made up of one or more modules of one or more different types of memory, and may be configured to store data and other information as well as operational instructions that may be used by the processor 206 to implement training mode detection/activation circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a training mode detection/activation circuit 210.

Communication circuit 201 may include either or both of a wireless transceiver circuit 202 with an associated antenna 214 and a wired I/O interface 204 with an associated hardwired data port (not illustrated). As this example illustrates, communications with training mode detection/activation circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by training mode detection/activation circuit 210 to/from other entities such as sensors 152, vehicle systems 158, and feedback systems 168.

Wired I/O interface 204 can include a transmitter and a receiver (not shown) for hardwired communications with other devices. For example, wired I/O interface 204 can provide a hardwired interface to other components, including sensors 152, vehicle systems 158, and feedback systems. Wired I/O interface 204 can communicate with other devices using Ethernet or any of a number of other wired communication protocols whether standardized, proprietary, open, point-to-point, networked or otherwise.

Power supply 210 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include, for example, sensors 152 such as those described above with reference to the example of FIG. 1. Sensors 152 can include additional sensors that may or not otherwise be included on a standard vehicle 10 with which the training mode 200 is implemented. In the illustrated example, sensors 152 include vehicle acceleration sensors 212, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation of assist-mode system 200.

Vehicle systems 158 can include any of a number of different vehicle components or subsystems used to control or monitor various aspects of the vehicle and its performance. In this example, the vehicle systems 158 include a GPS or other vehicle positioning system 272 and other vehicle systems 290. Vehicle systems may also include integrated systems that receive and communicate environmental data to the vehicle and other vehicle systems. For example, vehicles systems may include systems that receive traffic and/or weather data. Vehicle systems may also include navigation systems.

Feedback systems 168 include vehicle systems that may be configured to provide feedback or stimuli to a driver or passenger. Feedback systems 168, may include visual feedback systems. Visual feedback systems may include a heads up display (“HUD”) 274, a dashboard display 276, a mirror display 278, a hood display 278, a steering wheel display 282, an A-pillar display 280, or a visual display in or on any other area of the vehicle. Visual display information include visual stimuli in the form of lights with varying levels of brightness, lights with color, lights with specific blinking or flashing patterns, lights configured to activate at a specific time or at specific times, lights configured to activate in a specific spatial arrangement or to illuminate a specific vehicle features, and other visual information.

Feedback systems 168 may also include a seat human machine interface (“HMI”). The seat HMI 284 may be configured to deliver feedback to a driver using the driver's seat of the vehicle. Feedback may be haptic, kinesthetic, or may take some other form. Feedback systems may also include a steering wheel HMI 286. The steering wheel HMI 286 may be configured to deliver feedback to a driver using the steering wheel. Feedback may be haptic, kinesthetic, or some other type of feedback. Other feedback systems 288 may also be included. For example, another part of the vehicle with which the driver tends to maintain contact while driving may be configured to deliver feedback. Additionally, in an embodiment, audio feedback may be delivered using a vehicle's sound system.

During operation, training mode detection/activation circuit 210 can receive information from various vehicle sensors as part of the implementation of the training phase of the two-part framework. It should be understood that training mode detection/activation refers to an operating state of the vehicle/system corresponding to the training phase, and, during which, training mode detection/activation circuit instructs the vehicle to detect maneuvers and pair detect maneuvers with assigned stimuli to create an association in the driver's mind between the maneuver and the stimuli. Sensor data may indicate whether a driver is performing a certain type of maneuver of interest. Maneuvers of interest may be determined/set in advance and may relate to specific driving functions such as navigation, safe driving, compliant driving, and other types of driving. For example, maneuvers of interest may include braking, bringing a vehicle to a stop, activating a turn signal, activating the parking break, changing lanes, turning, and other types of relevant maneuvers. Sensors may be configured to detect each of these maneuvers and any other relevant type of maneuver.

In an embodiment, the training mode may be activated automatically at preset times. For example, the training mode may be automatically activated when the driver turns on the vehicle and may remain activated indefinitely. In another embodiment, the training mode may turn on at preset intervals. For example, training mode may automatically activate during the first week of each of month of the year. In another embodiment, training mode may activate automatically when a driver turns on a vehicle for the first time. Training mode may run for a set period. For example, training mode may run for three months. After the initial period expires, training mode may set to run again at another preset interval. For example, a second one month training mode may automatically activate a year after the first training mode began.

In another embodiment, a driver may manually activate the training mode by operating switch 205. Communication circuit 201 can be used to transmit and receive information between training mode detection/activation circuit 210 and sensors 152, and training mode detection/activation circuit 210 and vehicle systems 158 and feedback systems 168. Also, sensors 152 may communicate with vehicle systems 158 and feedback systems 168 directly or indirectly (e.g., via communication circuit 201 or otherwise).

In various embodiments, communication circuit 201 can be configured to receive data and other information from sensors 152 that is used in implementing the training mode. Additionally, communication circuit 201 can be used to send an activation signal or other activation information to various vehicle systems 158 and feedback systems 168 as part of implementing the training mode. For example, as described in more detail below, communication circuit 201 can be used to send signals to, for example, one or more of: HUD 274, dash display 276, mirror display 278, hood display 278, steering wheel display 282, A-pillar display 280, and other visual display systems to display visual stimuli. Signals may also be sent to seat HMI 284 and steering wheel HMI 286 to display other forms of feedback including haptic and kinesthetic feedback. The decision regarding which feedback systems 168 should present which types of stimuli can be made based on the information detected by sensors 152.

For example, a specific maneuver may have specific assigned stimuli. For instance, a specific maneuver may be braking and specific assigned stimuli corresponding to breaking may be a blinking red light. Other examples are possible. During the training phase, training mode detection/activation circuit 210 first detects a driver initiating and/or performing a maneuver and then communicates with feedback systems 168 to present stimuli corresponding to the detected maneuver. Vehicle systems may also communicate with sensors 152, training mode detection/activation circuit 210, and feedback systems 168. Examples of the functionality of the training mode are described in more detail below.

FIG. 3 illustrates an example architecture for activating a suggestion mode in accordance with one embodiment of the systems and methods described herein. Like the training mode depicted in FIG. 2, the suggestion mode 300 include a suggestion mode detection/activation circuit 310. The suggestion mode detection/activation circuit is configured to communicate with sensors 152, vehicle systems 158, and feedback systems 168 in the same way the training mode detection/activation circuit 210 communicates with these components. The description, above, at paragraphs [0050] to [0060] applies equally to the suggestion mode 300.

During operation, suggestion mode detection/activation circuit 310 can receive information from various vehicle sensors as part of the implementation of the suggestion phase of the two-part framework. It should be understood that suggestion mode detection/activation refers to an operating state of the vehicle/system corresponding to the suggestion phase, and, during which, suggestion mode detection/activation circuit instructs the vehicle to present stimuli to suggest/prompt a driver to perform a maneuver. The maneuver may be warranted by a detected driving scenario. Sensor data may indicate whether a particular driving scenario is present. Driving scenarios may be set in advance and may relate to specific driving scenarios in which suggesting a maneuver to a driver may be valuable. For example, driving scenarios may include an obstacle in the road, icy conditions, navigation instructions, situations in which signaling is required or useful, e.g., prior to making a lane change, legal scenarios, e.g., speed limit, and other relevant driving scenarios. Sensors may be configured to detect each of these scenarios and any other relevant type of scenario.

In an embodiment, the suggestion mode may be activated automatically at preset times. For example, the suggestion mode may be automatically activated when the training mode either concludes or is turned off by the driver. The suggestion mode may remain turned on indefinitely. The suggestion mode and training mode may also both run concurrently in an embodiment. In another embodiment, the suggestion mode may turn on at preset intervals. For example, the suggestion mode may turn on automatically after the training mode has been running for a period of three months. The suggestion mode may turn on regardless of whether the training mode is activated or not.

In another embodiment, a driver may manually activate the suggestion mode by operating switch 205. Communication circuit 201 can be used to transmit and receive information between suggestion mode detection/activation circuit 210 and sensors 152, and training mode detection/activation circuit 210 and vehicle systems 158 and feedback systems 168. Also, sensors 152 may communicate with vehicle systems 158 and feedback systems 168 directly or indirectly (e.g., via communication circuit 201 or otherwise).

In various embodiments, communication circuit 201 can be configured to receive data and other information from sensors 152 that is used in implementing the suggestion mode. Additionally, communication circuit 201 can be used to send an activation signal or other activation information to various vehicle systems 158 and feedback systems 168 as part of implementing the suggestion mode. For example, as described in more detail below, communication circuit 201 can be used to send signals to, for example, one or more of: HUD 274, dash display 276, mirror display 278, hood display 278, steering wheel display 282, A-pillar display 280, and other visual display systems to display visual stimuli. Signals may also be sent to seat HMI 284 and steering wheel HMI 286 to display other forms of feedback including haptic and kinesthetic feedback. The decision regarding which feedback systems 168 should present which types of stimuli can be made based on the information detected by sensors 152.

For example, a specific driving scenario may warrant a specific maneuver. For instance, icy conditions may warrant a reduction in speed. Reduction in speed may be a maneuver having assigned stimuli. The suggestion mode detection/activation circuit may receive an indication of the assigned stimuli from the training mode detection/activation circuit. The suggestion mode detection/activation circuit may then instruct feedback systems 168 to present the stimuli associated with the warranted maneuver. Vehicle systems 158 may also communicate with sensors 152, suggestion mode detection/activation circuit 310, and feedback systems 168. For instance, in a navigation mode a maneuver may be warranted based on navigation instructions instead of a detected driving scenario. Therefore, the suggestion mode detection/activation circuit 310 may communicate with both a GPS/VEH POS System 272 and feedback systems 168 to present stimuli corresponding to a maneuver warranted by navigation instructions.

During implementation of the suggestion mode 300, sensors 152 may also detect whether a driver has executed a warranted maneuver in accordance with the stimuli presented. For example, sensors may detect icy conditions. Icy conditions may warrant a reduction in speed. A reduction in speed may corresponding with assigned stimuli. The assigned stimuli may be blinking red lights. Based on its detection of the icy conditions and determination that a reduction in speed is warranted, suggestion mode detection/activation circuit may present the blinking red lights to the driver to suggest the driver reduce speed. The driver may associate blinking red lights with reduction in speed after having gone through a training phase (effectuated by training mode detection/activation circuit 210) in which blinking red lights were presented every time a driver reduced speed. The driver may, based on this association, reduce speed. Sensors may detect the resulting reduction in speed and relevant vehicle and environmental data. The driver may also override the suggestion. Sensors may detect that the driver has overridden the suggestion. More examples of the functionality of the suggestion mode are described in more detail below.

As discussed above, stimuli may be presented during the training phase, to create an association between a maneuver and stimuli in the driver's mind. During the training phase, presentation of stimuli follows a detected maneuver. Stimuli may also be presented during the suggestion phase, once the driver has formed an association, to suggest a particular maneuver to a driver based on a detected driving scenario. During the suggestion phase, the presentation of stimuli precedes a maneuver so that the stimuli may prompt/suggest the maneuver to the driver. Many types of stimuli are possible. For example stimuli make take the form of either or both of HMI feedback and task-related feedback. HMI feedback occurs when an operator uses an input interface to perform an action. Operators of vehicles may use an HMI to control the vehicle. Input interfaces may include the steering wheel, pedals, turn signal lever, and other physical vehicle controls. Output interfaces may also be included and may also deliver feedback. For example, output interfaces may include a cluster display or a heads-up display (“HUD”).

An operator may receive HMI feedback when the operator performs an action using the HMI. For example, an operator may press a mechanical push button, such as a push button located on a parking brake. When the operator depresses the push button, the operator may feel and hear a click. An operator may also receive feedback from an output interface. For example, an indicator on the dashboard may illuminate confirming that the parking brake has been activated. Feedback may be acoustic, haptic, optical, or some other type of feedback. An operator may also receive HMI feedback when, for example, an operator activates the turn signal of a vehicle. When the operator activates the turn signal, the operator may feel and hear a mechanical notch. Additionally, the vehicle may generate an electro-mechanical relay sound indicating the turn signal is active. Additionally, an arrow-shaped LED in the instrument cluster may illuminate and begin to blink.

An operator may also receive task-related feedback. Task-related feedback includes feedback that naturally occurs due to an action an operator takes. For example, an operator may be driving the vehicle in a straight path and may then decide to perform a task. The task may be turning the steering wheel so that the vehicle follows a bend in the road. Turning the steering wheel is an operator action as well as an HMI input. When the operator turns the wheel, the operator will naturally observe that the vehicle trajectory is changing according to the operator's steering action. This observation is an example of task-related feedback because the observation is a direct result of the task, turning the wheel, as opposed to HMI feedback. Other examples are also possible. For example, an operator may feel inertial forces that result from taking a particular action. Other tasks may include, for example, an operator applying the brakes. Task-related feedback corresponding to applying the brakes may include, for example, experiencing inertial forces and/or experiencing the seatbelt pressing against the operator's chest.

An operator may also experience HMI feedback while braking. For example, an operator may experience haptic feedback through the brake pedal. Haptic feedback may be provided through different types of actuators and/or mechanisms. For example an electromechanical vibrator may be attached to, connected to, and/or configured within the seat of the vehicle. Alternatively and/or additionally an electromechanical vibrator may be attached to, connected to, and/or configured within the steering wheel. In each situation, the electromechanical vibrator may vibrate the seat/wheel delivering haptic feedback to the driver. As another example, a haptic actuator may be a spinning motor. Other types of haptic actuators may also include eccentric rotating masses, linear resonant actuators, piezo haptic actuators, thermoelectric devices, solenoid actuators, ultrasonic transducers or sensors, and other types of actuators or mechanisms for delivering haptic feedback. Persons of skill in the art will understand how different actuators and/or mechanisms may be implemented to deliver haptic feedback.

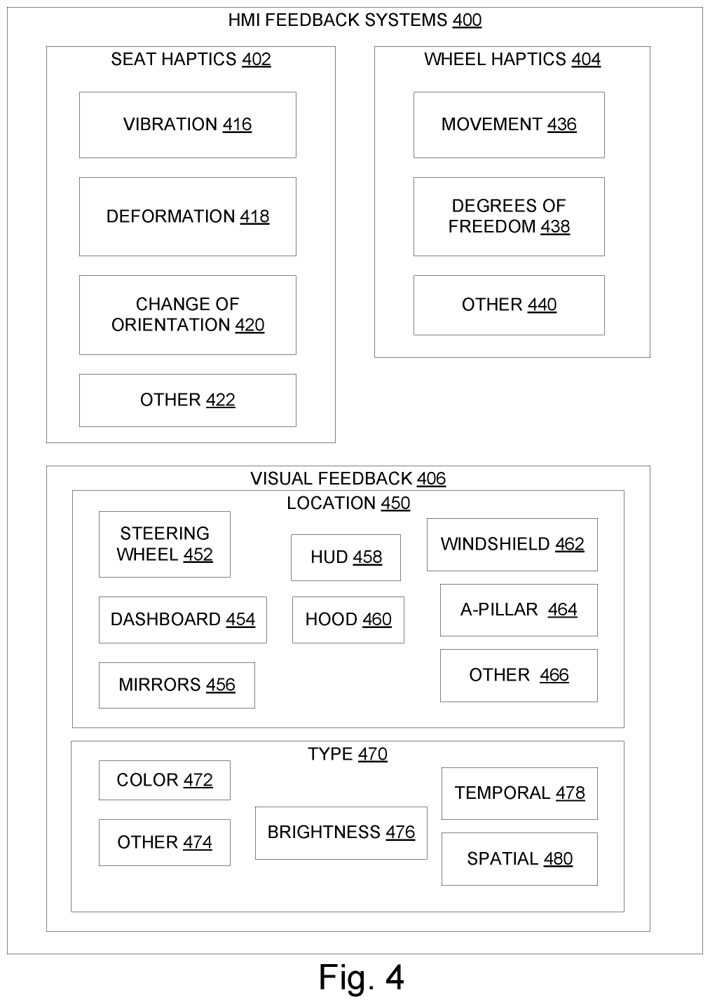

FIG. 4 is a diagram showing an example of HMI feedback systems 400 configured to present different types of stimuli. As discussed above, stimuli may be presented to a driver during both phases of the two-phase framework. Specifically, stimuli may be assigned to a particular maneuver and presented after the driver performs the specific maneuver during the training phase to create an association. During the suggestion phase, stimuli may be presented before a maneuver occurs to prompt/suggest the maneuver to the driver. As shown in FIG. 4, HMI feedback systems 400 may include seat haptics 402, wheel haptics 404, and visual feedback 406. Seat haptics 402 may include systems configured to deliver stimuli through a driver or passenger's seat. For example, the seat may vibrate 416. The seat may also deform 418. For example, the shape of the seat may change/contract. The orientation of the seat may also change 420. For example, the seat may shift forward or backward and/or the seatback angle may change. Other 422 haptic and/or kinesthetic feedback delivered through the seat may also be possible.

Wheel haptics 404 may include systems configured to deliver stimuli through the steering wheel. For example, the steering wheel may move 436. The steering wheel may vibrate. Degrees of freedom 438 of the steering wheel may be adjusted. Other types of feedback 440 may also be delivered through the steering wheel.

Visual feedback 406 may occur at different locations 450 in a vehicle. There are also may be different types of visual feedback 470. For example, locations 450 may include the steering wheel 452, dashboard 454, mirrors 456, HUD 458, hood 460, windshield 462, A-pillar 464, and other locations 466 in or on a vehicle. Types 470 of visual feedback may include color 472. For example, a colored light may activate or lights of a certain color may illuminate a certain vehicle component. Brightness 476 may also be a type of visual feedback. Lights may be configured and activated in a certain area of a vehicle 480. For example, lights may illuminate a particular vehicle component or may form a particular shape. Additionally, lights may activate in a particular temporal sequence 478 or at a particular time. Other types 474 of visual feedback are also possible.

As discussed above, the systems and method disclosed herein may include a two-phase framework. The two-phase framework may include a training phase and a suggestion phase. The training phase may occur prior to the suggestion phase. The training phase may also be repeated over time. A training phase involving the same stimuli and maneuvers may be repeated. In an embodiment, new training phases involving different stimuli and maneuvers may also occur. A training phase may range in duration from a period of several hours to a period of several months. The training phase may be repeated at regular intervals. For example, a training phase may be repeated monthly, quarterly, annually, or at other appropriate intervals.

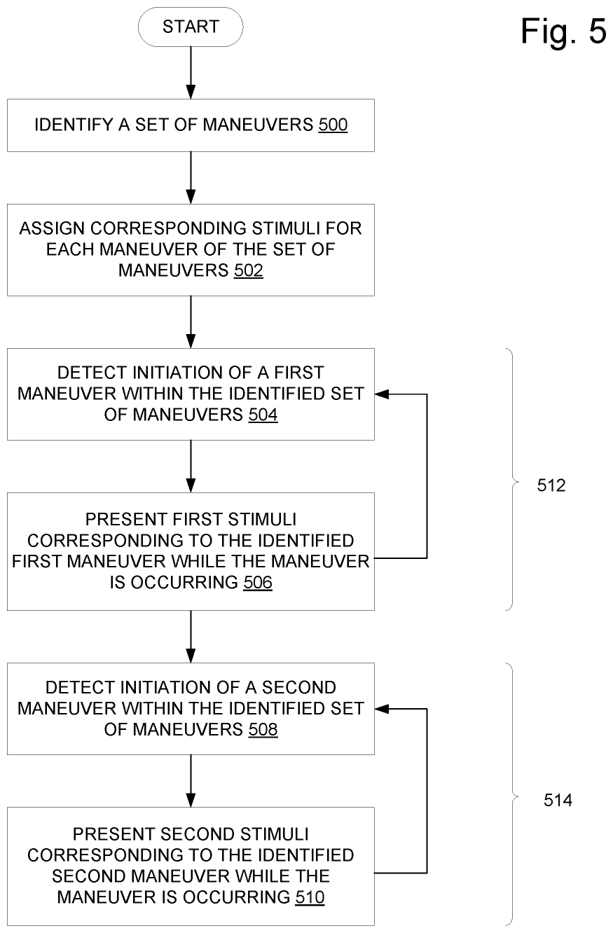

FIG. 5 is a flow diagram showing an example of a training method consistent with the training phase discussed above. As a first operation 500, a set of maneuvers may be identified. The set of maneuvers may include common and/or useful driving behaviors, although any maneuver may be of interest and identified. The selected maneuvers may be maneuvers that later, during the suggestion phase, would be desirable in certain driving scenarios. Maneuvers may include, for example, braking, bringing a vehicle to a stop, activating a turn signal, activating a parking break, performing a lane change, doing a physical, over the shoulder check before performing a lane change, turning, and other maneuvers relevant to safe, effective, and/or compliant driving.

As a second operation 502, corresponding stimuli may be assigned for each maneuver in the set of identified maneuvers. Assigned stimuli may be visual and/or haptic. Assigned stimuli may include the types of stimuli discussed above with reference to FIG. 4. One stimulus or stimuli may be assigned to each driving maneuver. For example, activating a red light on the HUD may be assigned to braking. In another embodiment, activating red lights on the HUD and A-pillars may be assigned to braking. Stimuli must be assigned carefully so as not to confuse the driver. For example, the same color stimuli likely should not be used for multiple different maneuvers. For example, if a red light is used, in any location, to indicate braking, a different colored light should be used to indicate acceleration. A different colored light should still be used even if the location of the stimuli different as between different maneuvers. The assignments discussed here are merely example assignments. Other assignments and combinations of stimuli and maneuvers are possible.

As a third operation 504, a training system may detect a first maneuver within the identified set of maneuvers 504. The maneuver may be detected using a sensor system, such as the sensors 152 described above with reference to FIG. 2. The maneuver may be detected at initiation. In other words, a driver many not need to fully complete the maneuver before the maneuver is detected. For example, the maneuver may be a lane change. The driver may have checked a blind spot and activated a turn signal but not yet completed the lane change at the time the lane change is detected. In another embodiment, the maneuver may be completed at the time of detection. For example, a driver may have already activated their turn signal at the time of detection.

As a fourth operation 506, a training system may present stimuli corresponding to the identified first maneuver while the maneuver is occurring. For example, as discussed above, the system may determine that a driver is initiating but has not yet completed a lane change. The system may then present the stimuli assigned to the lane change maneuver as the driver executed the lane change. In another embodiment, the stimuli may be displayed after the driver completes the maneuver. For example, lights illuminated in a pointing left type pattern on the HUD may be activated after a driver has activated their left hand turn signal. Other configurations are also possible.

The third and fourth operations 504, 506 may be repeated during a first maneuver training phase 512. During the first maneuver training phase 512, the assigned stimuli may be presented during and/or after the driver performs the first maneuver. The assigned stimuli may be time-correlated with the first maneuver. For instance, the assigned stimuli may be presented every time the driver performs the first maneuver. Overtime, the driver may come to associate the assigned stimuli with the first maneuver. Prior to the training phase, the assigned stimuli may not be the type of stimuli the driver would naturally associate with the first maneuver. In other words, the stimuli is neutral. After repetition, however, the driver may come to associate the stimuli with the first maneuver. In other words, the stimuli is now conditioned.

As a fifth operation 508, the training system may detect initiation and/or completion of a second maneuver within the identified set of maneuvers 508. As a sixth operation 510, the training system may present second stimuli corresponding to the identified second maneuver while and/or after the driver has performed the second maneuver. The fifth and sixth operations 508, 510 may be repeated during a second maneuver training phase 514. The fifth and sixth operations 508, 510 may proceed similarly to the third and fourth operations 504, 506. Other numbers of maneuvers and assigned stimuli beyond the first and second identified maneuvers and their assigned stimuli may also be included in the training method.

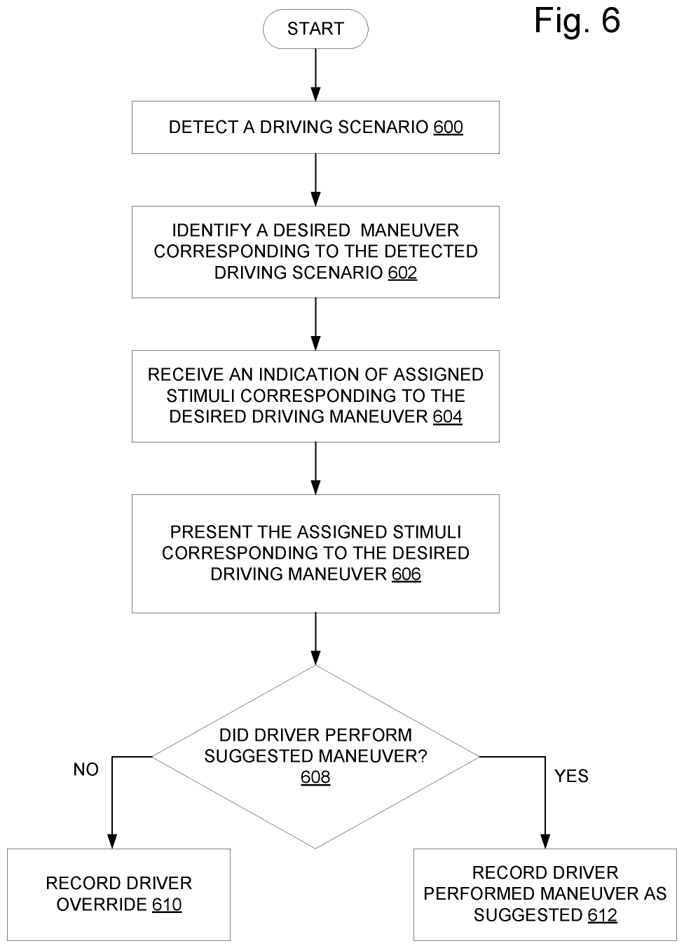

FIG. 6 is a flow diagram showing an example of a suggestion method consistent with the suggestion phase discussed above. During the suggestion phase, stimuli previously assigned and presented in the training phase may now serve as a trigger. In other words, instead of presenting the assigned stimuli after or while a driver has performed a maneuver, the stimuli may be presented to serve as a trigger/prompt to suggest the associated maneuver to the driver. As in the training phase, stimuli may be audio, visual, or tactical and may corresponding to a specific maneuver.

As a first operation 600, a suggestion method may include detecting a driving scenario. A driving scenario may be any set of driving conditions during which taking specific maneuvers may be desirable. Driving scenarios may be rule-based. For example, a driving scenario may comprise a stop sign ahead. Driving scenarios may also be risk-based. For example, a driving scenario may comprise an obstacle in the path of a vehicle. Driving scenarios may also be navigation based. For example, to take the most efficient route to a destination, a driver may need to merge onto the freeway. Driving scenarios may also include broader scenarios in which certain maneuvers are desired. For example, a driving scenario may include any situation in which a driver should or must communicate with other drivers. A driving scenario may also include any situation in which a driver should or must move the vehicle laterally, i.e., by operating the steering wheel. A driving scenario may also include any situation in which a driver should or must move the vehicle longitudinally, i.e., by braking or accelerating.

Driving scenarios may be detected using the sensors described above with reference to FIG. 3. For example, camera sensors may detect a stop sign or other rule-based scenario. Data from vehicle systems may also aid in detecting rule-based scenarios. Temperature sensors may be used, for example, to detect a risk-based scenario, such as icy road conditions. Vehicle systems, such as a GPS system, may indicate information important to a navigation based scenario. Other systems and sensors may be used, separately or together, to detect driving scenarios.

As a second operation 602, a suggestion method may include identifying a desired maneuver corresponding to the detected driving scenario. For example, in the rule-based scenario discussed above, bringing the vehicle to a stop may be a desired maneuver corresponding to identification of a stop sign ahead. As another example, in the risk-based scenario discussed above, braking may be a desired maneuver corresponding to the identification of an obstacle in the road. As another example, in the navigation based scenario discussed above, merging may be a desired maneuver corresponding to the need for a driver to merge onto the freeway to follow navigation instructions. Other maneuvers may correspond to other situations.

As a third operation 604, a suggestion method may include receiving an indication of assigned stimuli corresponding to the desired driving maneuver 606. The stimuli may have been assigned during a training phase, discussed above. The driver may now, based on training, have a mental model associating the stimuli with the desired driving maneuver. The driver may have formed this mental model when assigned stimuli was presented every time a driver performed a desired maneuver during the training phase. In the training phase, a driver may not have performed a desired maneuver in response to the detected driving scenario. For example, a driver may brake for any number of reasons. A driver may brake to bring the speed of a vehicle within legal limits, because the driver will soon be parking or stopping the vehicle, because conditions are dangerous, because a bend in the road is approaching, because an obstacle is present ahead, or for any number of reasons.

During the training phase, assigned stimuli may be presented each time a driver performed a maneuver regardless of the surrounding context for the maneuver. For example, stimuli assigned to breaking may be red light indicators on visual display locations. The red lights may be presented every time a driver brakes. For example, the red lights may be applied when the driver is slowing down because a bend in the road is approaching, when the driver is slowing down to enter a parking lot, when the driver is slowing down because the driver observes an obstacle in the road, or for any other reason. In the suggestion phase, however, the assigned stimuli serves as a trigger, prompt, or suggestion for a specific maneuver because the maneuver corresponds to a detected driving scenario in which the maneuver would be desired.

As a fourth operation 606, the suggestion method may include presenting the assigned stimuli corresponding to the desired driving maneuver. Due to the driver's association of the stimuli and maneuver formed during the training phase, it may feel natural and/or instinctual for the driver to perform the maneuver based on the presented stimuli. In this way the stimuli now serves as a trigger/prompt for the maneuver. Though the association between the stimuli and the maneuver may be strong, a driver still retains ultimate control of the vehicle. The maneuver will not occur unless the driver chooses to physically perform the maneuver. A driver may choose to override the suggestion if the maneuver is not appropriate or the driver does not want to perform the maneuver.

As a fifth operation 608, the suggestion method may consider whether the driver performed the suggestion maneuver. As discussed above, even though the association between the stimuli and maneuver may be strong, a driver still retains ultimate control of the vehicle and must still choose whether or not to perform the prompted maneuver. If the driver does in fact perform the suggested maneuver, the suggestion method may, as a sixth operation 612, record the fact that the driver performed the maneuver as suggested. If a driver performs a maneuver, this may provide an indication that the maneuver was appropriate and/or warranted. An indication that a maneuver was warranted and/or appropriate may serve as useful information in refining and strengthening the suggestion method. Additionally, artificial intelligence (“AI”) and/or machine learning techniques may be used to perform the suggestion method. Therefore, this kind of indication may improve the accuracy of the suggestion method in an AI and/or machine learning context.

If a driver chooses to override the suggested maneuver, the suggestion method may, as an alternative fifth operation 610, record an indication that the driver has overridden the suggestion. If a driver overrides a suggested maneuver, this may provide an indication that the maneuver was not appropriate and/or warranted. An indication that a maneuver was not warranted and/or appropriate may serve as useful information in refining and strengthening the suggestion method. Additionally, artificial intelligence (“AI”) and/or machine learning techniques may be used to perform the suggestion method. Therefore, this kind of indication may improve the accuracy of the suggestion method in an AI and/or machine learning context.

### Stimuli Linking Embodiment

In another embodiment, two or more sets of stimuli, each associated with a specific maneuver, may be linked to suggest a single maneuver or natural sequence of maneuvers. For example, specific maneuvers may be linked to other maneuvers that are likely to follow a specific maneuver. A system may leverage intelligence and/or other statistical data to determine which maneuvers are likely to progress in sequence and thus to determine which maneuvers may be good candidates for stimuli linking. For example, statistically, many drivers may perform a turn after activating their turn signal. Therefore, these two specific maneuvers, actuating a turn signal and turning, are likely to progress in sequence.

Initially, during a training phase, a system may operate as described above. Namely, the system may provide a distinct set of assigned stimuli for each maneuver. The system may assign a first set of stimuli for activation of the turn signal. The system may then assign a second set of stimuli for turning. Each of stimuli may be presented after the driver performs the specific corresponding maneuver. Each time a driver activates the turn signal, the first stimuli may be presented. Each time a driver turns, the second stimuli may be presented. A driver may form an association between the first set of stimuli and the turn signals as well as between the second set of stimuli and turning.

During the suggestion phase, the stimuli may be presented before a driver performs a maneuver to prompt/trigger the specific maneuver. Both stimuli may be initially presented even if the specific maneuvers should occur in sequence. In other words, the first stimuli may be presented and the driver may activate the turn signal. The second stimuli may be presented and the driver may turn. As discussed above with reference to FIG. 6, sensors, such as those described with reference to FIGS. 2 and 3, may detect whether the driver has performed the maneuver in accordance with the suggestion. However, the sensors may determine, over time, that for a sequence of maneuvers, only one stimuli is needed to trigger the sequence. For example, the sensors may detect that once prompted to activate the turn signal, a driver will activate the turn signal and then turn the vehicle. Sensors may confirm a driver will perform these maneuvers in sequence. The suggestion phase may then prompt the entire sequence (activating the turn signal and turning) using only the first set of stimuli, associated with activating the turn signal). Sensors may confirm that even though only the first stimuli is presented, a driver will still perform the whole sequence, without additional prompting. Using only one stimuli to suggest a sequence of maneuvers and/or multiple maneuvers may decrease processing time and latency which may enable safer and more responsive driving. Stimuli linking, as described above with reference to activating the turn signal and turning, may also be used for other maneuvers that either occur in sequence or that a driver is likely to perform based only on one set of assigned stimuli. For example, a driver may bring the vehicle to a stop and then put the vehicle into park. One set of stimuli may trigger both of these maneuvers (stopping the vehicle and putting the vehicle into park).

In another embodiment, a training phase be updated to reflect and reinforce stimuli linking. For instance, in the above example involving activating the turn signal and turning, a training method may continue to present the assigned first set of stimuli after a driver activates the turn signal, to reinforce the connection. However, the training method may stop presenting the second set of stimuli each time the driver has performed a turn. Eliminating the second set of stimuli from the pairing with turning may free up processing capability for training.

In another embodiment, stimuli may be linked based on relationships between maneuvers. For example, one primary maneuver may be linked with multiple sub-maneuvers. For example, activating the turn signal may be a primary maneuver because it precedes other maneuvers. For example, a driver may activate the turn signal before either making a turn or changing lanes. In this example changing lanes and turning may be sub-maneuvers. A primary maneuver may be assigned to a primary stimulus. For example, a primary stimulus may be haptic feedback delivered through the steering wheel. For example, haptic feedback delivered through the steering wheel may be used to prompt/trigger a driver to activate their turn signal.

Secondary stimuli may be assigned to sub-maneuvers. For example, two different visual indications may be assigned to each of turning and making a lane change. During the training phase, the primary stimulus may follow the primary maneuver to build an association. The secondary stimulus assigned to each sub-maneuver may be presented after each respective sub-maneuver. Then, during the suggestion phase, the primary stimulus may be presented to prompt the primary maneuver. For examples, haptic feedback may be delivered through the steering wheel to activate the turn signal. However, the driver may still be unsure of which sub-maneuver to take. A secondary stimulus may then be delivered to indicate which sub-maneuver a driver should take. For example, a visual display on the steering wheel may prompt the driver to turn. A different visual display, such as a different color light, on the steering wheel may prompt the driver to change lanes. Other examples of sets of maneuvers and sub-maneuvers paired with primary and secondary stimuli may also be possible.

### Stimuli Reassignment Embodiment

In an embodiment, the systems and methods disclosed herein may perform a reassignment of stimuli. As discussed above, stimuli may be presented during both the training and suggestion phases of the two-part framework. During the training phase, an assigned set of stimuli may be presented immediately after a driver performs a specific maneuver. The same set of stimuli may be presented every time the drive performs the specific maneuver to create an association in the driver's mind between the stimuli and the maneuver. Then, during the suggestion phase, the same set of stimuli may be presented before the driver performs the specific maneuver in order to prompt/trigger the driver the perform the specific maneuver. It may be desirable for the driver to perform the specific maneuver to navigate a detected driving scenario. Presenting the stimuli may provide strong encouragement for the driver to perform the maneuver based on the association created during the training phase.

In an embodiment, it may be desirable to reassign stimuli. For example, stimuli assigned to a specific maneuver may include a selected audio tone. The audio tone may play after the driver performs a specific maneuver. The specific maneuver may be making a left hand turn. Therefore, the audio tone may play every time the driver performs a left hand turn during the training phase to train the driver to associate the audio tone with performing a left hand turn. However, during the suggestion phase, it may not be very useful to prompt the driver to make left hand turns. It may be much more useful to prompt the driver to apply the brakes to slow down the vehicle. It may be more useful to prompt the driver to brake because this driver may frequently driver in icy conditions, for example. Therefore, it may desirable to reassign the audio tone to braking instead of making a left hand turn. To reassign the stimuli, the training phase must be repeated with the assigned stimuli, for example, the audio tone, and the new specific maneuver, for example, braking. The training phase must repeat for a sufficient duration to replace the old association in the driver's mind between the assigned stimuli and the older maneuver with the a new association between the assigned stimuli and the new maneuver. For example, extensive training with the audio tone and braking may cause the driver to replace their association between the audio tone and making a left turn with an association between the audio tone and braking. Other examples of stimuli reassignment are also possible. Stimuli reassignment may be desirable in a variety of situations.

### Stimuli Optimization Embodiment

In another embodiment, systems supporting a training and suggestion framework may be configured to optimize the stimuli assigned to each maneuver. During the training phase, assigned stimuli may be presented after a driver performs a specific maneuver. The stimuli may be presented each time the driver performs the specific maneuver to create an association in the driver's mind between the assigned stimuli and the specific maneuver. In an embodiment, certain types of assigned stimuli may pair better with specific maneuvers, creating a stronger association. For example, assigned stimuli for braking could include an LED indicator on the dashboard. In another example, assigned stimuli for braking could include haptic feedback delivered through the driver's seat. Haptic feedback delivered through the driver's seat may, in an embodiment, form a stronger association with braking than an LED indicator.

During the suggestion phase, the assigned stimuli precedes the specific maneuver and acts as a prompt/trigger to suggest the maneuver to the driver based on a detected driving situation. As discussed above with reference to FIG. 6, a system may detect whether a driver has performed a maneuver suggested during the training phase or has overridden the suggestion. The detection may be performed using vehicle sensors such as the sensors described above with reference to FIGS. 2 and 3. In an example, an LED indicator may be paired with braking during the training phase. During the suggestion phase, the LED indicator may be presented to suggest braking. A driver may frequently override this stimuli and not brake in response to the indicator. A driver frequently overriding stimuli may suggest the stimuli is not optimal.

In another example, haptic feedback delivered through the driver's seat may be presented to suggest braking during the suggestion phase. A driver may brake frequently in response to the haptic feedback. The system may detect this braking in response to the haptic feedback and determine that haptic feedback is an optimal stimuli for braking. The system may then continue to provide haptic feedback for braking and/or reassign stimuli such that haptic feedback delivered through the seat is paired with braking. Overtime, a system may leverage sensors to determine whether a driver is implementing or overriding suggested maneuvers. The system may learn which assigned stimuli pair best with specific maneuvers and may implement those pairings, as discussed above with reference to the LED indicator and haptic feedback examples. Other example stimuli are also possible.

### Communication Embodiment

In an embodiment, the systems and methods disclosed herein may be implemented to improve driver communication actions. A communication action may include any action which a driver takes to indicate information to another driver. For example, a communication action may include actions that indicate that a driver intends to perform a maneuver. For example, a driver may activate a turn signal. Activating a turn signal may be a communication action that indicates intent to turn the vehicle or change lanes so that other drivers may plan their trajectories. Communication actions may also include hand signals, honking the horn, activating flashers, and other actions intended to communicate information to other drivers.

If a driver performs a communication action often, a driver may by trained to form an association between that action and assigned stimuli. For example, a driver may activate a turn signal often. A driver may likely activate a turn signal at least once every time the driver drives the vehicle so activating a turn signal may be a communication action for which a driver may be trained to form an association. Other communication actions performed often may also be good candidates for training.

Activating a turn signal may also be an action that may benefit from suggestion. Though drivers use turn signals often, drivers may not activate turn signals at optimal times. For example, a driver may activate a turn signal while performing a turn or immediately prior to performing a turn. Activating the turn signal at this time may not provide sufficient notice to other drivers of the driver's intent to perform a turn. Therefore, drivers may benefit from prompting to ensure drivers use their turn signals at appropriate times. Other communication actions benefitting from prompting for more appropriate use may also benefit from suggestion.

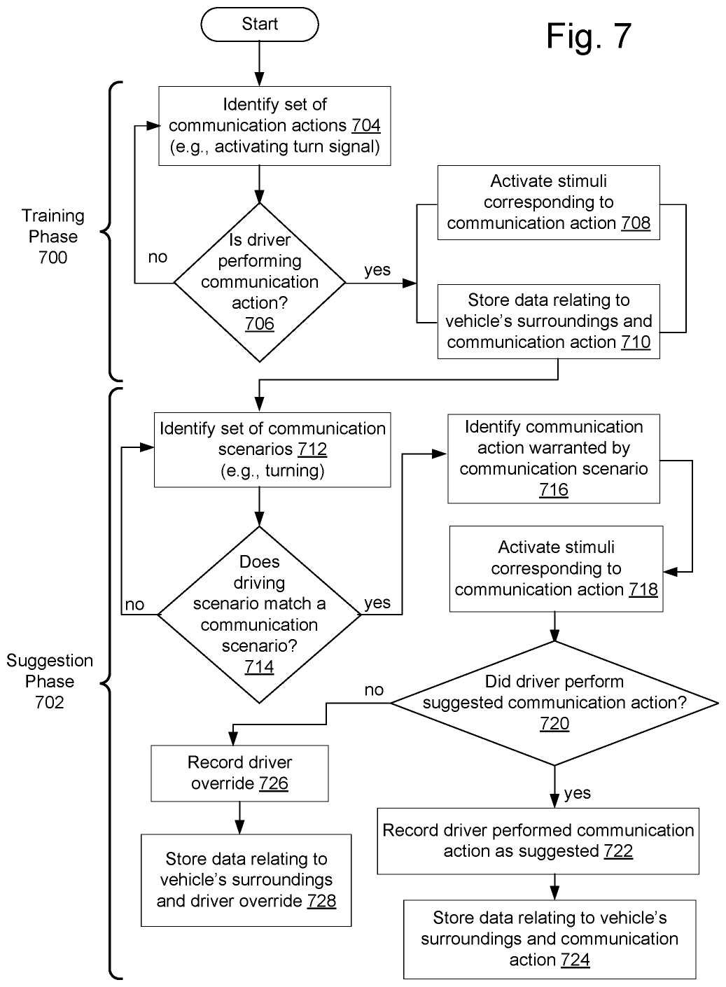

FIG. 7 is a flow diagram showing an example of a training and suggestion method for communication actions in accordance with the systems and methods disclosed herein. A training and suggestion method for communication actions may include two phases. The two phases may be a training phase 700 and a suggestion phase 702. Though the two phases are separate, they may occur concurrently in an embodiment. For example, the training phase 700 may continue to occur while the suggestion phase 702 is occurring. The suggestion phase 702, however, cannot occur until the training phase 700 has occurred for at least some period of time.

During the training phase 700, a first operation 704 may include identifying a set of communication actions. The identified communication actions may be actions that a driver performed to indicate information to other drivers, as discussed above. The identified communication actions may also be actions that a driver performs frequently such that an association between a communication action and stimuli may be conditioned. The identified communication actions may also be actions that may benefit from suggestion for more appropriate and/or effective use.

As a second operation 706 during the training phase, the method may determine whether a driver is performing a communication action. The system may determine whether a driver is performing a communication action leveraging the sensors, vehicle systems, and training mode detection/activation circuit discussed above with reference to FIG. 2. If a driver is not performing a communication action, the method may include continuing to monitor for a communication action. If a driver is in fact performing one of the identified communication actions, the method may include, as a third operation 708, activating stimuli corresponding to the detected communication action 708. In the training phase 700, stimuli may be activated whether or not the driver is performing the communication action in an appropriate and/or effective way. The goal of the training phase 700 is to form an association in the driver's mind between the stimuli and the communication action. The goal is not to indicate the appropriateness of the action.

The assigned stimuli corresponding to the communication action may take many forms. In an embodiment, the assigned stimuli may take the form of visual feedback. Visual feedback may be presented on the HUD, dashboard, a-pillars, or some other appropriate location in or on the vehicle. Visual feedback may include LED indicators. Visual feedback comprising assigned stimuli may have selected, unified characteristics. For example, visual feedback may be a particular color. It may be a particular shape such as, for example, an arrow. It may be of a particular brightness. It may be a particular flash pattern. Other types of visual feedback are also possible.

In an embodiment, the assigned stimuli may take the form of either visual and/or tactile feedback. The feedback may be delivered on or through the steering wheel of the vehicle. For example visual feedback may include a visual display on the steering wheel, such as, illumination of the steering wheel. Tactile feedback may include haptic and/or kinesthetic feedback. For example, haptic feedback may include vibration of the steering wheel. Kinesthetic feedback may involve feedback that changes the position and/or orientation of the driver's body or body parts. For example if a driver is grasping a steering wheel and the steering wheel moves, the driver's hands/arms will also move which may offer a source of kinesthetic feedback.

In an embodiment, the assigned stimuli may take the form of tactile feedback delivered through the seat of the vehicle. Tactile feedback may include haptic and/or kinesthetic feedback. For example, haptic feedback may include vibration of the seat. Kinesthetic feedback may involve feedback that changes the position and/or orientation of the driver's body or body parts. For example if a driver is sitting in the seat and the seat moves, the driver's body will also move which may offer a source of kinesthetic feedback.

In an embodiment, the assigned stimuli may take the form of tactile feedback delivered through the pedal or pedals of the vehicle. Tactile feedback may include haptic and/or kinesthetic feedback. For example, haptic feedback may include vibration of the pedal. Kinesthetic feedback may involve feedback that changes the position and/or orientation of the driver's body or body parts. For example if a driver is applying their foot to the pedal and the pedal moves, the driver's foot will also move which may offer a source of kinesthetic feedback.

As a fourth operation 710, the method may store data relating to the vehicle's surroundings and the communication action. Storing related data may assist in refining and strengthening the training method.

The operations of the training phase 700 may repeat aid the driver in forming an association between identified communication actions and assigned stimuli corresponding to each communication action. For example, the second 706 and third 708 operations may repeat each time a driver performs a communication action to build the association. The training phase 700 may run for a set period of time. The training phase may also continue indefinitely. The training phase may also repeat periodically at selected intervals.

After the training phase 700 has run for at least a period sufficient for a driver to form an association between communication actions and their assigned stimuli, the suggestion phase 702 may begin. As a first operation 712 of the suggestion phase, the method may include identifying a set of scenarios communication scenarios in which suggestion would be valuable. For example, scenarios may include performing a turn and/or performing a lane change. With those scenarios, the method may include identifying the time and/or distance at which the communication action should occur. For example, if the scenario includes turning, activating a turn signal (communication) should occur at about 100 feet prior to where the turn is set to occur.

As a second operation 714 of the suggestion phase 702, the method may include determining whether a current driving scenario matches one of the identified communication scenario. This determination may be performed by leveraging the sensors, vehicle systems, and suggestion mode detection/activation circuit described above with reference to FIG. 3. For example, a current driving situation may be a situation in which a driver is expected to make a turn in about 100 feet. Sensor may detect an intersection or driveway ahead, for example. Vehicle data including GPS data and/or past route data may indicate a driver will make a turn at the intersection or driveway based on past routes. A situation in which a driver is expected to turn in about 100 feet is a situation in which a driver should activate the turn signal. Therefore, the current driving situation likely matches a communication scenario. Other examples are also possible.

If the current driving scenario does not match a communication scenario, the method may include continuing to monitor the current driving scenario for a match. If the current driving scenario does in fact match one of the identified communication scenarios, then, as a third operation 716, the method may include identifying a communication action warranted by the communication scenario 716. For instance, in the above example the current driving scenario was one in which a driver was expected to turn at an intersection about 100 feet ahead. A communication action warranted by that scenario may be activating the turn signal. The warranted communication action, activating the turn signal, for example, may corresponding to assigned stimuli. The driver may have formed an association between the communication action and assigned stimuli in during the training phase 700. Now during the suggestion phase, as a fourth operation 718, the method may include activating the stimuli corresponding to the communication action. In the suggestion phase 702, activating the stimuli serves as a trigger/prompt to suggest that the driver take the warranted maneuver.

As a fifth operation 720, the method may include determining whether the performed the suggested communication action. This determination may be performed by leveraging the sensors, vehicle systems, and suggestion mode detection/activation circuit described above with reference to FIG. 3. For example, vehicle sensors may confirm that the driver did in fact activate the turn signal. If the driver does in fact perform the suggested communication action, the method may, as a sixth operation 722, record the fact that the driver performed the communication action as suggested. As a seventh operation 724, the method may including storing data relating to the vehicle's surroundings and communication action. If a driver performs the communication action, this may provide an indication that the action was appropriate and/or warranted. Recording that the driver performed the action and storing related data may assist in refining and strengthening the method.

If a driver chooses to override the suggested communication action, the method may, as an alternative sixth operation 726, record an indication that the driver has overridden the suggested communication action. As an alternative seventh operation 728, the method may include storing data relating to the vehicle's surroundings and driver override. Driver override may provide an indication that the maneuver was not appropriate and/or warranted. Recording the override and storing related data may assist in refining and strengthening the method.

### Lateral Control Embodiment

In an embodiment, the systems and methods disclosed herein may be implemented to improve safety, efficiency, and compliance of driving by improving lateral control of a vehicle. Lateral control of a vehicle may include any action which a driver takes that changes the orientation of the vehicle relative to the road ahead. For example, a lateral control action may include turning, merging, performing a lane changes, and other maneuvers that change the position and/or orientation of the vehicle relative to its current trajectory.

If a driver performs a lateral control action often, a driver may by trained to form an association between that action and assigned stimuli. For example, a driver may make turns often. A driver may likely turn at least once every time the driver drives the vehicle so turning may be a lateral control action for which a driver may be trained to form an association. Other lateral control actions performed often may also be good candidates for training.

Turning a vehicle may also be an action that may benefit from suggestion. Drivers turn often, in many contexts, however it may be valuable to prompt a driver to turn in certain scenarios. For example, it may be helpful to prompt a driver to turn in a navigation scenario or if an obstacle is blocking the driver's path. Therefore, drivers may benefit from prompting to help drivers turn in particular situations. Other lateral control actions benefitting from prompting may also benefit from suggestion.

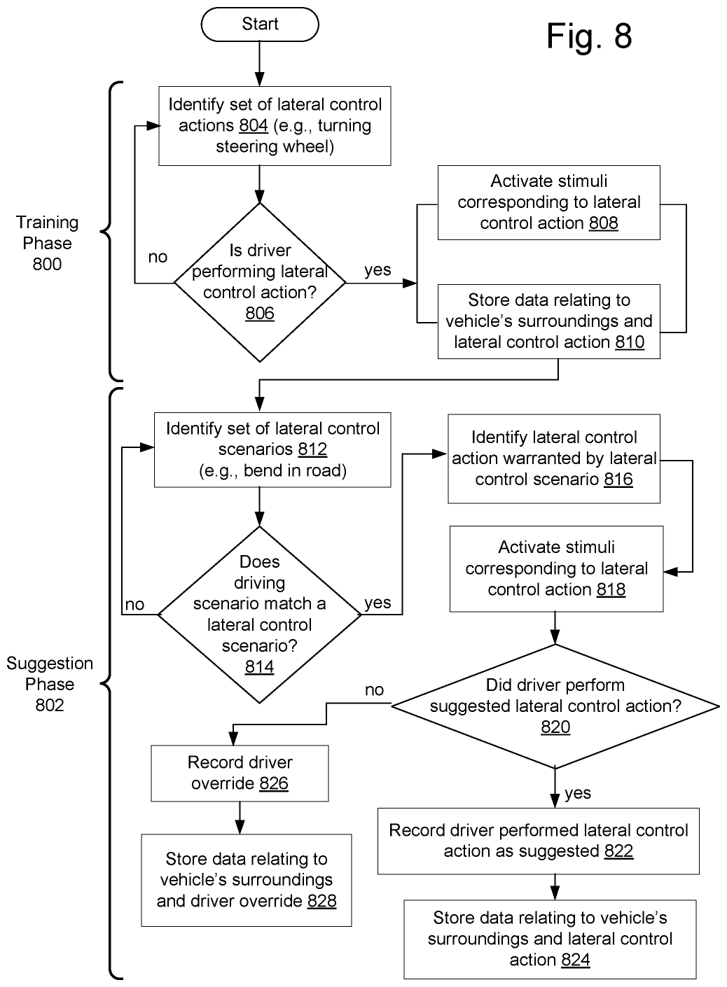

FIG. 8 is a flow diagram showing an example of a training and suggestion method for lateral control actions in accordance with the systems and methods disclosed herein. A training and suggestion method for lateral control actions may include two phases. The two phases may be a training phase 800 and a suggestion phase 802. Though the two phases are separate, they may occur concurrently in an embodiment. For example, the training phase 800 may continue to occur while the suggestion phase 802 is occurring. The suggestion phase 802, however, cannot occur until the training phase 800 has occurred for at least some period of time.

During the training phase 800, a first operation 804 may include identifying a set of lateral control actions. The identified lateral control actions may be maneuvers that a driver performs to change the vehicle's position and/or orientation relative to its current trajectory, as discussed above. The identified lateral control actions may also comprise actions that a driver performs frequently such that an association between a lateral control action and stimuli may be conditioned. The identified lateral control actions may also be actions that may benefit from suggestion.

As a second operation 806 during the training phase, the method may determine whether a driver is performing a lateral control action. The system may determine whether a driver is performing a lateral control action leveraging the sensors, vehicle systems, and training mode detection/activation circuit discussed above with reference to FIG. 2. If a driver is not performing a lateral control action, the method may include continuing to monitor for a lateral control action. If a driver is in fact performing one of the identified lateral control actions, the method may include, as a third operation 808, activating stimuli corresponding to the detected lateral control action 808. In the training phase 800, stimuli may be activated whether or not the driver is performing the lateral control action in a particular scenario, i.e., navigation. The goal of the training phase 800 is to form an association in the driver's mind between the stimuli and the lateral control action. The goal is not to indicate the appropriateness of the action for a particular situation.

The assigned stimuli corresponding to the lateral control action may take many forms. In an embodiment, the assigned stimuli may take the form of visual feedback. Visual feedback may be presented on the HUD, dashboard, a-pillars, or some other appropriate location in or on the vehicle. Visual feedback may include LED indicators. Visual feedback comprising assigned stimuli may have selected, unified characteristics. For example, visual feedback may be a particular color. It may be a particular shape such as, for example, an arrow. It may be of a particular brightness. It may be a particular flash pattern. Other types of visual feedback are also possible.

In an embodiment, the assigned stimuli may take the form of either visual and/or tactile feedback. The feedback may be delivered on or through the steering wheel of the vehicle. For example visual feedback may include a visual display on the steering wheel, such as, illumination of the steering wheel. Tactile feedback may include haptic and/or kinesthetic feedback. For example, haptic feedback may include vibration of the steering wheel. Kinesthetic feedback may involve feedback that changes the position and/or orientation of the driver's body or body parts. For example if a driver is grasping a steering wheel and the steering wheel moves, the driver's hands/arms will also move which may offer a source of kinesthetic feedback.

In an embodiment, the assigned stimuli may take the form of tactile feedback delivered through the seat of the vehicle. Tactile feedback may include haptic and/or kinesthetic feedback. For example, haptic feedback may include vibration of the seat. Kinesthetic feedback may involve feedback that changes the position and/or orientation of the driver's body or body parts. For example if a driver is sitting in the seat and the seat moves, the driver's body will also move which may offer a source of kinesthetic feedback.

As a fourth operation 810, the method may store data relating to the vehicle's surroundings and the lateral control action. Storing related data may assist in refining and strengthening the training method.

The operations of the training phase 800 may repeat to aid the driver in forming an association between identified lateral control actions and assigned stimuli corresponding to each lateral control action. For example, the second 806 and third 808 operations may repeat each time a driver performs a lateral control action to build the association. The training phase 800 may run for a set period of time. The training phase may also continue indefinitely. The training phase may also repeat periodically at selected intervals.

After the training phase 800 has run for at least a period sufficient for a driver to form an association between lateral control actions and their assigned stimuli, the suggestion phase 802 may begin. As a first operation 812 of the suggestion phase, the method may include identifying a set of lateral control scenarios in which suggestion would be valuable. For example, scenarios may include navigation scenarios, obstacle avoidance scenarios, and other scenarios where changing the vehicles current trajectory would be valuable.

As a second operation 814 of the suggestion phase 802, the method may include determining whether a current driving scenario matches one of the identified lateral control scenarios. This determination may be performed by leveraging the sensors, vehicle systems, and suggestion mode detection/activation circuit described above with reference to FIG. 3. For example, a current driving situation may be a situation in which a driver must make a turn to follow navigational instructions. Sensors may detect an intersection ahead, for example. Vehicle data including GPS data and/or past route data may indicate that driver needs to turn at the intersection stay on route. Because a lateral control action is warranted to stay on route, the current driving situation is a lateral control situation. Other examples are also possible.

If the current driving scenario does not match a lateral control scenario, the method may include continuing to monitor the current driving scenario for a match. If the current driving scenario does in fact match one of the identified lateral control scenarios, then, as a third operation 816, the method may include identifying a lateral control action warranted by the lateral control scenario 816. For instance, in the above example the driver must turn (lateral control action) to stay on route. The warranted lateral control action, turning, for example, may corresponding to assigned stimuli. The driver may have formed an association between the lateral control action and assigned stimuli in during the training phase 800. Now during the suggestion phase, as a fourth operation 818, the method may include activating the stimuli corresponding to the lateral control action. In the suggestion phase 802, activating the stimuli serves as a trigger/prompt to suggest that the driver take the warranted maneuver.

As a fifth operation 820, the method may include determining whether the performed the suggested lateral control action. This determination may be performed by leveraging the sensors, vehicle systems, and suggestion mode detection/activation circuit described above with reference to FIG. 3. For example, vehicle sensors may confirm that the driver did in fact turn. If the driver does in fact perform the suggested lateral control action, the method may, as a sixth operation 822, record the fact that the driver performed the lateral control action as suggested. As a seventh operation 824, the method may including storing data relating to the vehicle's surroundings and lateral control action. If a driver performs the lateral control action, this may provide an indication that the action was appropriate and/or warranted. Recording that the driver performed the action and storing related data may assist in refining and strengthening the method.

If a driver chooses to override the suggested lateral control action, the method may, as an alternative sixth operation 826, record an indication that the driver has overridden the suggested lateral control action. As an alternative seventh operation 828, the method may include storing data relating to the vehicle's surroundings and driver override. Driver override may provide an indication that the maneuver was not appropriate and/or warranted. Recording the override and storing related data may assist in refining and strengthening the method.

### Longitudinal Control Embodiment

In an embodiment, the systems and methods disclosed herein may be implemented to improve safety, efficiency, and compliance of driving by improving longitudinal control of a vehicle. Longitudinal control of a vehicle may include any action which a driver takes that changes the vehicles position along its current trajectory. For example, a longitudinal control action may include braking, accelerating and other maneuvers that change the longitudinal position of the vehicle.

If a driver performs a longitudinal control action often, a driver may by trained to form an association between that action and assigned stimuli. For example, a driver may brake often. A driver may likely brake several times each time the driver drives the vehicle so braking may be a longitudinal control action for which a driver may be trained to form an association. Other longitudinal control actions performed often may also be good candidates for training.

Braking may also be an action that may benefit from suggestion. Drivers brake often, in many contexts, however it may be valuable to prompt a driver to brake in certain scenarios. For example, it may be helpful to prompt a driver to brake if an obstacle is blocking the driver's path. Therefore, drivers may benefit from prompting to help drivers brake in particular situations. Other longitudinal control actions benefitting from prompting may also benefit from suggestion.

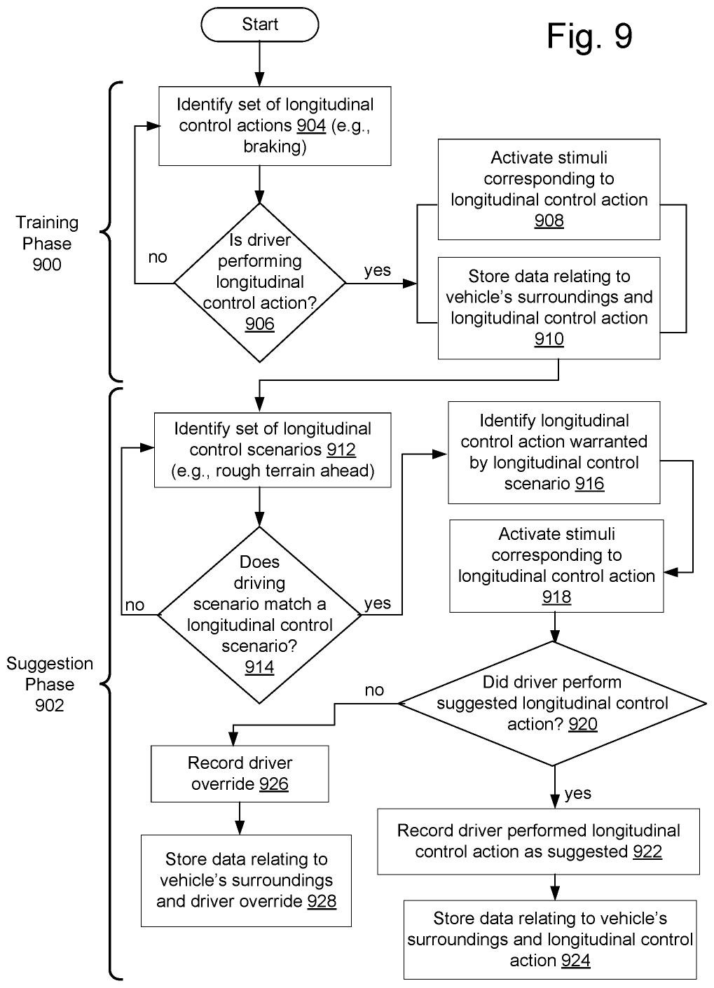

FIG. 9 is a flow diagram showing an example of a training and suggestion method for longitudinal control actions in accordance with the systems and methods disclosed herein. A training and suggestion method for longitudinal control actions may include two phases. The two phases may be a training phase 900 and a suggestion phase 902. Though the two phases are separate, they may occur concurrently in an embodiment. For example, the training phase 900 may continue to occur while the suggestion phase 902 is occurring. The suggestion phase 902, however, cannot occur until the training phase 900 has occurred for at least some period of time.

During the training phase 900, a first operation 904 may include identifying a set of longitudinal control actions. The identified longitudinal control actions may be maneuvers that change a vehicle's longitudinal position, as discussed above. The identified longitudinal control actions may also be actions that a driver performs frequently such that an association between a longitudinal control action and stimuli may be conditioned. The identified longitudinal control actions may also be actions that may benefit from suggestion for more appropriate and/or effective use.

As a second operation 906 during the training phase, the method may determine whether a driver is performing a longitudinal control action. The system may determine whether a driver is performing a longitudinal control action leveraging the sensors, vehicle systems, and training mode detection/activation circuit discussed above with reference to FIG. 2. If a driver is not performing a longitudinal control action, the method may include continuing to monitor for a longitudinal control action. If a driver is in fact performing one of the identified longitudinal control actions, the method may include, as a third operation 908, activating stimuli corresponding to the detected longitudinal control action 908. In the training phase 900, stimuli may be activated whether or not the driver is performing the longitudinal control action in an appropriate and/or effective way. The goal of the training phase 900 is to form an association in the driver's mind between the stimuli and the longitudinal control action. The goal is not to indicate the appropriateness of the action.

The assigned stimuli corresponding to the longitudinal control action may take many forms. In an embodiment, the assigned stimuli may take the form of visual feedback. Visual feedback may be presented on the HUD, dashboard, a-pillars, or some other appropriate location in or on the vehicle. Visual feedback may include LED indicators. Visual feedback comprising assigned stimuli may have selected, unified characteristics. For example, visual feedback may be a particular color. It may be a particular shape such as, for example, an arrow. It may be of a particular brightness. It may be a particular flash pattern. Other types of visual feedback are also possible.

In an embodiment, the assigned stimuli may take the form of either visual and/or tactile feedback. The feedback may be delivered on or through the steering wheel of the vehicle. For example visual feedback may include a visual display on the steering wheel, such as, illumination of the steering wheel. Tactile feedback may include haptic and/or kinesthetic feedback. For example, haptic feedback may include vibration of the steering wheel. Kinesthetic feedback may involve feedback that changes the position and/or orientation of the driver's body or body parts. For example if a driver is grasping a steering wheel and the steering wheel moves, the driver's hands/arms will also move which may offer a source of kinesthetic feedback.

In an embodiment, the assigned stimuli may take the form of tactile feedback delivered through the seat of the vehicle. Tactile feedback may include haptic and/or kinesthetic feedback. For example, haptic feedback may include vibration of the seat. Kinesthetic feedback may involve feedback that changes the position and/or orientation of the driver's body or body parts. For example if a driver is sitting in the seat and the seat moves, the driver's body will also move which may offer a source of kinesthetic feedback.

In an embodiment, the assigned stimuli may take the form of tactile feedback delivered through the pedal or pedals of the vehicle. Tactile feedback may include haptic and/or kinesthetic feedback. For example, haptic feedback may include vibration of the pedal. Kinesthetic feedback may involve feedback that changes the position and/or orientation of the driver's body or body parts. For example if a driver is applying their foot to the pedal and the pedal moves, the driver's foot will also move which may offer a source of kinesthetic feedback.

As a fourth operation 910, the method may store data relating to the vehicle's surroundings and the longitudinal control action. Storing related data may assist in refining and strengthening the training method.

The operations of the training phase 900 may repeat aid the driver in forming an association between identified longitudinal control actions and assigned stimuli corresponding to each longitudinal control action. For example, the second 906 and third 908 operations may repeat each time a driver performs a longitudinal control action to build the association. The training phase 900 may run for a set period of time. The training phase may also continue indefinitely. The training phase may also repeat periodically at selected intervals.

After the training phase 900 has run for at least a period sufficient for a driver to form an association between longitudinal control actions and their assigned stimuli, the suggestion phase 902 may begin. As a first operation 912 of the suggestion phase, the method may include identifying a set of longitudinal control scenarios in which suggestion would be valuable. For example, scenarios may include an obstacle blocking the road or a hill ahead.

As a second operation 914 of the suggestion phase 902, the method may include determining whether a current driving scenario matches one of the identified longitudinal control scenarios. This determination may be performed by leveraging the sensors, vehicle systems, and suggestion mode detection/activation circuit described above with reference to FIG. 3. For example, a current driving situation may be a situation in which a driver must or should accelerate to maintain their current speed. Sensors may detect a hill ahead, for example. Vehicle data including GPS data and topographical data may also indicate that a hill is ahead. To maintain is current speed while traveling up the hill, a driver will need to accelerate. Therefore, the current driving situation (hill ahead) likely matches a longitudinal control scenario. Other examples are also possible.

If the current driving scenario does not match a longitudinal control scenario, the method may include continuing to monitor the current driving scenario for a match. If the current driving scenario does in fact match one of the identified longitudinal control scenarios, then, as a third operation 916, the method may include identifying a longitudinal control action warranted by the communication scenario 916. For instance, in the above example the current driving scenario was one in which a driver was approaching a hill. A longitudinal control action warranted by that scenario may be accelerating to maintain speed while navigating the hill. The warranted longitudinal control action, accelerating, for example, may corresponding to assigned stimuli. The driver may have formed an association between the longitudinal control action and assigned stimuli in during the training phase 900. Now during the suggestion phase, as a fourth operation 918, the method may include activating the stimuli corresponding to the longitudinal control action. In the suggestion phase 902, activating the stimuli serves as a trigger/prompt to suggest that the driver take the warranted maneuver.

As a fifth operation 920, the method may include determining whether the driver performed the suggested longitudinal control action. This determination may be performed by leveraging the sensors, vehicle systems, and suggestion mode detection/activation circuit described above with reference to FIG. 3. For example, vehicle sensors may confirm that the driver did in fact accelerate. If the driver does in fact perform the suggested longitudinal control action, the method may, as a sixth operation 922, record the fact that the driver performed the longitudinal control action as suggested. As a seventh operation 924, the method may including storing data relating to the vehicle's surroundings and longitudinal control action. If a driver performs the longitudinal control action, this may provide an indication that the action was appropriate and/or warranted. Recording that the driver performed the action and storing related data may assist in refining and strengthening the method.

If a driver chooses to override the suggested longitudinal control action, the method may, as an alternative sixth operation 926, record an indication that the driver has overridden the suggested longitudinal control action. As an alternative seventh operation 928, the method may include storing data relating to the vehicle's surroundings and driver override. Driver override may provide an indication that the maneuver was not appropriate and/or warranted. Recording the override and storing related data may assist in refining and strengthening the method.

### Overtake Embodiment

In an embodiment, the systems and methods disclosed herein may be implemented to improve driver overtake actions. An overtake action may include any action which a driver overtakes or attempts to overtake another vehicle. For example, an overtake action may include actions such as performing a lane change and accelerating as well as other overtake actions.

If a driver performs an overtake action often, a driver may by trained to form an association between that action and assigned stimuli. For example, a driver that commutes daily on the freeway may overtake other drivers often. Therefore, overtake maneuvers may be maneuvers for which a driver may be trained to form an association.

Overtake actions may benefit from suggestion. Though drivers perform overtake actions often, drivers may not necessarily perform them at optimal times or using optimal technique. For example, a driver may wait behind a slower driving and become increasingly more agitated until the driver ultimately executes a sloppy and needlessly aggressive overtake action, which may put other drivers at risk. Therefore, prompting drivers to execute overtake actions more proactively may be valuable.

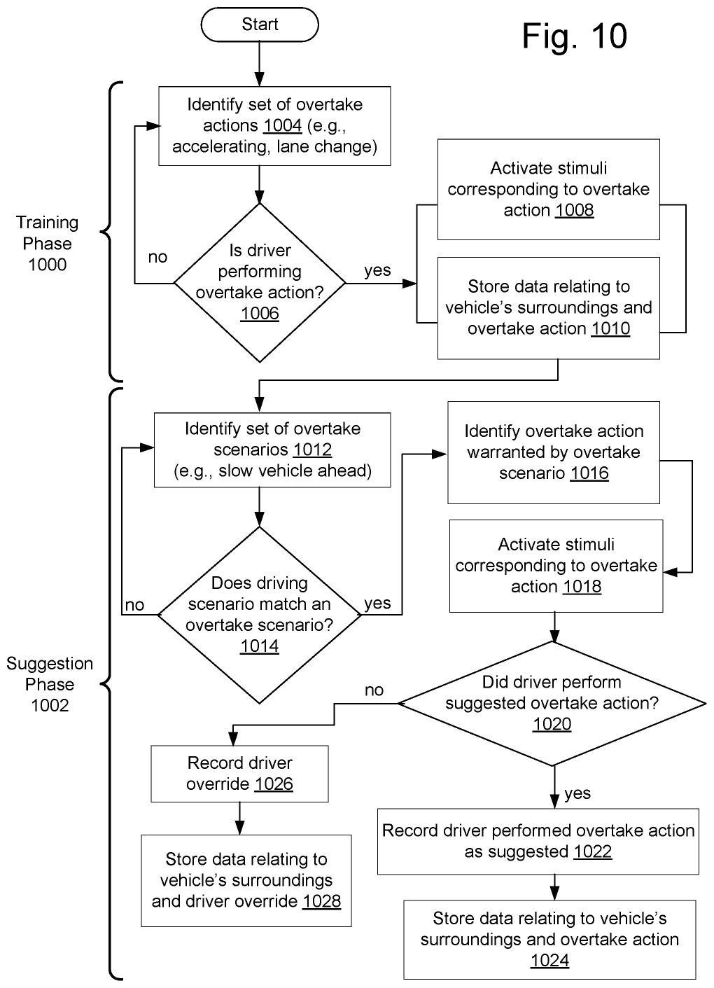

FIG. 10 is a flow diagram showing an example of a training and suggestion method for overtake actions in accordance with the systems and methods disclosed herein. A training and suggestion method for overtake actions may include two phases. The two phases may be a training phase 1000 and a suggestion phase 1002. Though the two phases are separate, they may occur concurrently in an embodiment. For example, the training phase 1000 may continue to occur while the suggestion phase 1002 is occurring. The suggestion phase 1002, however, cannot occur until the training phase 1000 has occurred for at least some period of time.

During the training phase 1000, a first operation 1004 may include identifying a set of overtake actions. The identified overtake actions may be actions that a driver performs when overtaking other drivers, such as lane changes and acceleration, as discussed above. The identified overtake actions may also be actions that a driver performs frequently such that an association between an overtake action and stimuli may be conditioned. The identified overtake actions may also be actions that may benefit from suggestion for more appropriate and/or effective use.

As a second operation 1006 during the training phase, the method may determine whether a driver is performing an overtake action. The system may determine whether a driver is performing an overtake action leveraging the sensors, vehicle systems, and training mode detection/activation circuit discussed above with reference to FIG. 2. If a driver is not performing an overtake action, the method may include continuing to monitor for an overtake action. If a driver is in fact performing one of the identified overtake actions, the method may include, as a third operation 1008, activating stimuli corresponding to the detected overtake action 1008. In the training phase 1000, stimuli may be activated whether or not the driver is performing the overtake action in an appropriate and/or effective way. The goal of the training phase 1000 is to form an association in the driver's mind between the stimuli and the overtake action. The goal is not to indicate the appropriateness of the action.

The assigned stimuli corresponding to the overtake action may take many forms. In an embodiment, the assigned stimuli may take the form of visual feedback. Visual feedback may be presented on the HUD, dashboard, a-pillars, or some other appropriate location in or on the vehicle. Visual feedback may include LED indicators. Visual feedback comprising assigned stimuli may have selected, unified characteristics. For example, visual feedback may be a particular color. It may be a particular shape such as, for example, an arrow. It may be of a particular brightness. It may be a particular flash pattern. Other types of visual feedback are also possible.

In an embodiment, the assigned stimuli may take the form of tactile feedback delivered through the seat of the vehicle. Tactile feedback may include haptic and/or kinesthetic feedback. For example, haptic feedback may include vibration of the seat. Kinesthetic feedback may involve feedback that changes the position and/or orientation of the driver's body or body parts. For example if a driver is sitting in the seat and the seat moves, the driver's body will also move which may offer a source of kinesthetic feedback.

In an embodiment, an overtake action may be an action that comprises several maneuvers, when done properly. For example, a driver may look over their shoulder, check their mirrors, return their focus to the road, activate a turn signal, execute a lane change, and accelerate. Each of these actions may have their own assigned stimuli. Stimuli may be presented in sequence to prompt the overall overtake action.

As a fourth operation 1010, the method may store data relating to the vehicle's surroundings and the overtake action. Storing related data may assist in refining and strengthening the training method.

The operations of the training phase 1000 may repeat aid the driver in forming an association between identified overtake actions and assigned stimuli corresponding to each overtake action. For example, the second 1006 and third 1008 operations may repeat each time a driver performs an overtake action to build the association. The training phase 1000 may run for a set period of time. The training phase may also continue indefinitely. The training phase may also repeat periodically at selected intervals.

After the training phase 1000 has run for at least a period sufficient for a driver to form an association between overtake actions and their assigned stimuli, the suggestion phase 1002 may begin. As a first operation 1012 of the suggestion phase, the method may include identifying a set of overtake scenarios in which suggestion would be valuable. For example, scenarios may include a slow moving vehicle immediately preceding an ego vehicle.

As a second operation 1014 of the suggestion phase 1002, the method may include determining whether a current driving scenario matches one of the identified overtake scenarios. This determination may be performed by leveraging the sensors, vehicle systems, and suggestion mode detection/activation circuit described above with reference to FIG. 3. For example, a current driving situation may be a situation in which a slow moving vehicle is immediately preceding the ego vehicle. Sensor may detect a slow moving vehicle ahead as well as its speed relative to the ego vehicle. For example, sensors may capture the rate at which the ego vehicle is closing the distance separating it from the slow moving vehicle. A slow moving vehicle ahead is a situation in which a driver would likely want to take an overtake maneuver. Therefore, the current driving situation likely matches an overtake scenario. Other examples are also possible.

If the current driving scenario does not match an overtake scenario, the method may include continuing to monitor the current driving scenario for a match. If the current driving scenario does in fact match one of the identified overtake scenarios, then, as a third operation 1016, the method may include identifying an overtake action warranted by the communication scenario 1016. For instance, in the above example the current driving scenario was one in which a slow moving vehicle was preceding the ego vehicle. Overtake actions warranted by that scenario may be include checking for clearance, making a lane change, and/or accelerating. The warranted overtake action(s) may each correspond to assigned stimuli. The driver may have formed an association between the overtake action and assigned stimuli in during the training phase 1000. Now during the suggestion phase, as a fourth operation 1018, the method may include activating the stimuli corresponding to the overtake action. In the suggestion phase 1002, activating the stimuli serves as a trigger/prompt to suggest that the driver take the warranted maneuver.

As a fifth operation 1020, the method may include determining whether the performed the suggested overtake action. This determination may be performed by leveraging the sensors, vehicle systems, and suggestion mode detection/activation circuit described above with reference to FIG. 3. For example, vehicle sensors may confirm that a driver did in fact perform a lane change and accelerate past a slow moving vehicle. If the driver does in fact perform the suggested overtake action, the method may, as a sixth operation 1022, record the fact that the driver performed the overtake action as suggested. As a seventh operation 1024, the method may include storing data relating to the vehicle's surroundings and overtake action. If a driver performs the overtake action, this may provide an indication that the action was appropriate and/or warranted. Recording that the driver performed the action and storing related data may assist in refining and strengthening the method.

If a driver chooses to override the suggested overtake action, the method may, as an alternative sixth operation 1026, record an indication that the driver has overridden the suggested communication action. As an alternative seventh operation 1028, the method may include storing data relating to the vehicle's surroundings and driver override. Driver override may provide an indication that the maneuver was not appropriate and/or warranted. Recording the override and storing related data may assist in refining and strengthening the method.

### Risk-Based Maneuver Embodiment

In an embodiment, the systems and methods disclosed herein may be implemented to improve driver response to risk situations. A risk situation may include any situation in which a driver faces a potential danger or difficulty while driving. For example, risk situations may include an obstacle in the road, rough terrain, icy conditions, dense traffic, a distracted nearby driver, and any other condition that may present a safety risk to a driver, passenger and/or other person on or around a road area.

A driver may perform certain maneuvers frequently. Some of these maneuvers may be beneficial in navigating risk situations, as described above. For example, braking, changing lanes, and other maneuvers may be beneficial in navigating risk. If a driver performs an action often, a driver may by trained to form an association between that action and assigned stimuli. For example, a driver may brake often. A driver likely brakes multiple times every time the driver drives the vehicle so braking may be a maneuver for which a driver may be trained to form an association. Other communication actions performed often may also be good candidates for training.

Any maneuver advantageous in navigating a risk situation may benefit from suggestion. Though drivers perform maneuvers such as braking or changing lanes often, drivers may not be prepared to perform these maneuvers in a risk situation so prompting may be helpful. For example, a driver may not observe an obstacle in the road until it is too late to avoid the obstacle. Therefore, prompting a driver to slow down, for example, may increase driving safety.

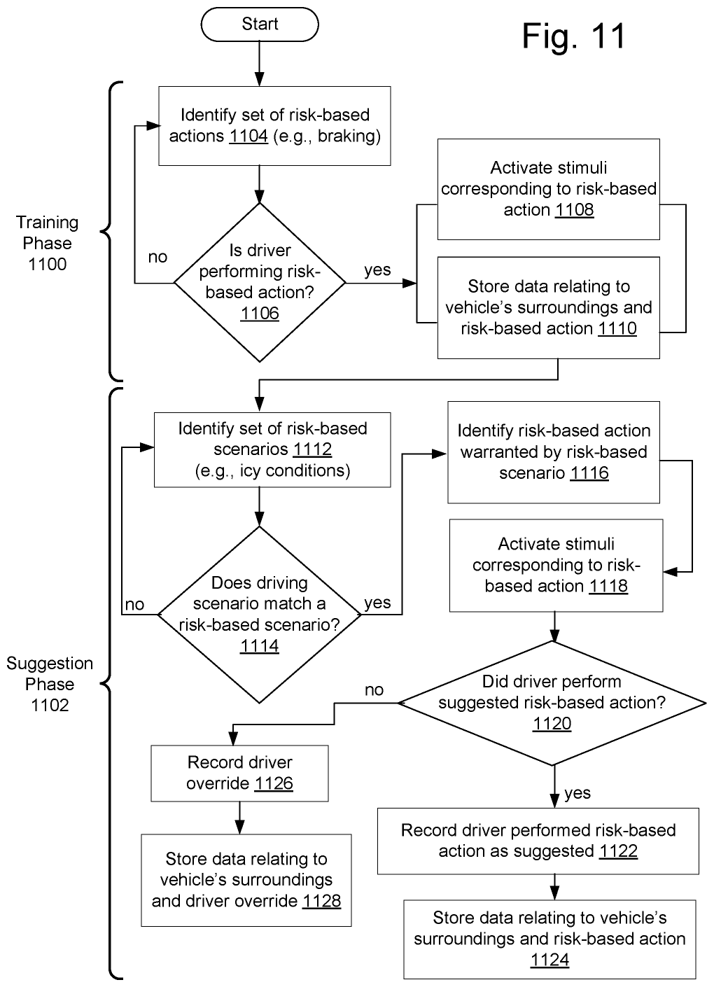

FIG. 11 is a flow diagram showing an example of a training and suggestion method for risk-based actions in accordance with the systems and methods disclosed herein. A training and suggestion method for risk-based actions may include two phases. The two phases may be a training phase 1100 and a suggestion phase 1102. Though the two phases are separate, they may occur concurrently in an embodiment. For example, the training phase 1100 may continue to occur while the suggestion phase 1102 is occurring. The suggestion phase 1102, however, cannot occur until the training phase 1100 has occurred for at least some period of time.

During the training phase 1100, a first operation 1104 may include identifying a set of risk-based actions. The identified risk-based actions may be actions maneuvers that would benefit a driver in navigating a risk situation, as discussed above. The identified risk-based actions may also be actions that a driver performs frequently such that an association between a risk-based action and stimuli may be conditioned. The identified risk-based actions may also be actions that may benefit from suggestion so that a driver can implement them to navigate a risk situation.

As a second operation 1106 during the training phase, the method may determine whether a driver is performing a risk-based action. The system may determine whether a driver is performing a risk-based action leveraging the sensors, vehicle systems, and training mode detection/activation circuit discussed above with reference to FIG. 2. If a driver is not performing a risk-based action, the method may include continuing to monitor for a risk-based action. If a driver is in fact performing one of the identified risk-based actions, the method may include, as a third operation 1108, activating stimuli corresponding to the detected risk-based action 1108. In the training phase 1100, stimuli may be activated whether or not the driver is performing the risk-based action in response to a risk situation. The goal of the training phase 1100 is to form an association in the driver's mind between the stimuli and the risk-based action. The goal is not to indicate the appropriateness of the action as a response to a risk situation.

The assigned stimuli corresponding to the risk-based action may take many forms. In an embodiment, the assigned stimuli may take the form of visual feedback. Visual feedback may be presented on the HUD, dashboard, a-pillars, or some other appropriate location in or on the vehicle. Visual feedback may include LED indicators. Visual feedback comprising assigned stimuli may have selected, unified characteristics. For example, visual feedback may be a particular color. It may be a particular shape such as, for example, an arrow. It may be of a particular brightness. It may be a particular flash pattern. Other types of visual feedback are also possible.

In an embodiment, the assigned stimuli may take the form of tactile feedback delivered through the seat of the vehicle. Tactile feedback may include haptic and/or kinesthetic feedback. For example, haptic feedback may include vibration of the seat. Kinesthetic feedback may involve feedback that changes the position and/or orientation of the driver's body or body parts. For example if a driver is sitting in the seat and the seat moves, the driver's body will also move which may offer a source of kinesthetic feedback.

As a fourth operation 1110, the method may store data relating to the vehicle's surroundings and the risk-based action. Storing related data may assist in refining and strengthening the training method.

The operations of the training phase 1100 may repeat to aid the driver in forming an association between identified risk-based actions and assigned stimuli corresponding to each risk-based action. For example, the second 1106 and third 1108 operations may repeat each time a driver performs a risk-based action to build the association. The training phase 1100 may run for a set period of time. The training phase may also continue indefinitely. The training phase may also repeat periodically at selected intervals.

After the training phase 1100 has run for at least a period sufficient for a driver to form an association between risk-based actions and their assigned stimuli, the suggestion phase 1102 may begin. As a first operation 1112 of the suggestion phase, the method may include identifying a set of risk situations in which suggestion would be valuable. For example, scenarios may include an obstacle in the road, rough terrain, dangerous weather affecting road conditions, a nearby out of control vehicle, and other risk situations.

As a second operation 1114 of the suggestion phase 1102, the method may include determining whether a current driving scenario matches one of the identified risk-based scenarios. This determination may be performed by leveraging the sensors, vehicle systems, and suggestion mode detection/activation circuit described above with reference to FIG. 3. For example, a current driving situation may be a situation in which a vehicle is approaching an obstacle in the road. Sensor may detect the obstacle ahead, for example. Therefore, the current driving situation likely matches a risk-based scenario. Other examples are also possible.

If the current driving scenario does not match a risk-based scenario, the method may include continuing to monitor the current driving scenario for a match. If the current driving scenario does in fact match one of the identified risk-based scenarios, then, as a third operation 1116, the method may include identifying a risk-based action warranted by the risk-based scenario 1116. For instance, in the above example the current driving scenario was one in which a driver an obstacle was present in the road ahead. A risk-based action warranted by the presence of the obstacle may be braking. The warranted risk-based action, braking, for example, may correspond to assigned stimuli. The driver may have formed an association between the risk-based action and assigned stimuli during the training phase 1100. Now during the suggestion phase, as a fourth operation 1118, the method may include activating the stimuli corresponding to the risk-based action. In the suggestion phase 1102, activating the stimuli serves as a trigger/prompt to suggest that the driver take the warranted maneuver.

As a fifth operation 1120, the method may include determining whether the driver performed the suggested risk-based action. This determination may be performed by leveraging the sensors, vehicle systems, and suggestion mode detection/activation circuit described above with reference to FIG. 3. For example, vehicle sensors may confirm that the driver did in fact brake. If the driver does in fact perform the suggested risk-based action, the method may, as a sixth operation 1122, record the fact that the driver performed the risk-based action as suggested. As a seventh operation 1124, the method may including storing data relating to the vehicle's surroundings and risk-based action. If a driver performs the risk-based action, this may provide an indication that the action was appropriate and/or warranted. Recording that the driver performed the action and storing related data may assist in refining and strengthening the method.

If a driver chooses to override the suggested risk-based action, the method may, as an alternative sixth operation 1126, record an indication that the driver has overridden the suggested risk-based action. As an alternative seventh operation 1128, the method may include storing data relating to the vehicle's surroundings and driver override. Driver override may provide an indication that the maneuver was not appropriate and/or warranted. Recording the override and storing related data may assist in refining and strengthening the method.

### Rule-Based Maneuver Embodiment

In an embodiment, the systems and methods disclosed herein may be implemented to improve driver response to rule situations. A rule situation may include any situation in which a driver should or must comply with a legal rule while driving. For example, rule situations may include driving through an area with a posted speed limit, approaching a stop sign or traffic light, driving in a lane in which the driver must turn left or right, or other situations in which a driver should or must obey a legal rule for the area in which the driver is operating the vehicle.

A driver may perform certain maneuvers frequently. Some of these maneuvers may be beneficial in navigating rule situations, as described above. For example, bringing a vehicle to a stop, reducing speed, turning, and other maneuvers may be beneficial in navigating rule situations. If a driver performs an action often, a driver may by trained to form an association between that action and assigned stimuli. For example, a driver may brake often. A driver likely brakes multiple times every time the driver drives the vehicle so braking may be a maneuver for which a driver may be trained to form an association. Other actions performed often may also be good candidates for training.

Any maneuver advantageous in navigating a rule situation may benefit from suggestion. Though drivers perform maneuvers such as braking or turning often, drivers may not be prepared to perform these maneuvers in a rule situation so prompting may be helpful. For example, a driver may be distracted and not observe a stop sign until it is too late to come to a complete stop before reaching the intersection. Therefore, prompting a driver to bring the vehicle to a stop, for example, may increase driving safety and compliance with the law.

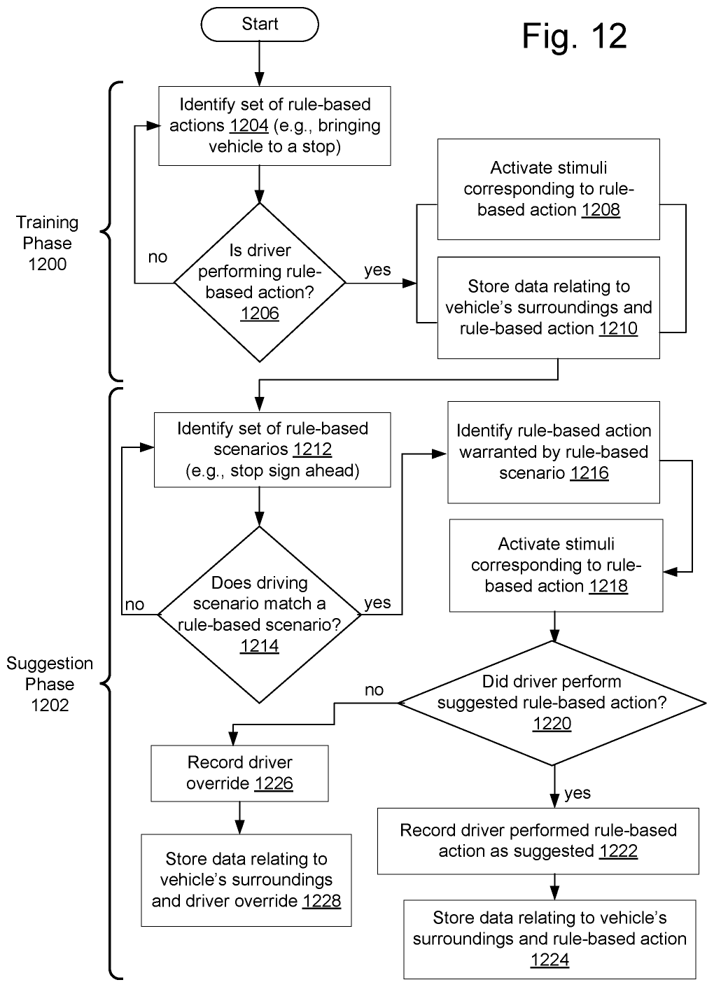

FIG. 12 is a flow diagram showing an example of a training and suggestion method for rule-based actions in accordance with the systems and methods disclosed herein. A training and suggestion method for rule-based actions may include two phases. The two phases may be a training phase 1200 and a suggestion phase 1202. Though the two phases are separate, they may occur concurrently in an embodiment. For example, the training phase 1200 may continue to occur while the suggestion phase 1202 is occurring. The suggestion phase 1202, however, cannot occur until the training phase 1200 has occurred for at least some period of time.

During the training phase 1200, a first operation 1204 may include identifying a set of rule-based actions. The identified rule-based actions may be maneuvers that would benefit a driver in navigating a rule situation, as discussed above. The identified rule-based actions may also be actions that a driver performs frequently such that an association between a rule-based action and stimuli may be conditioned. The identified rule-based actions may also be actions that may benefit from suggestion so that a driver can implement them to navigate a rule situation.

As a second operation 1206 during the training phase, the method may determine whether a driver is performing a rule-based action. The system may determine whether a driver is performing a rule-based action leveraging the sensors, vehicle systems, and training mode detection/activation circuit discussed above with reference to FIG. 2. If a driver is not performing a rule-based action, the method may include continuing to monitor for a rule-based action. If a driver is in fact performing one of the identified rule-based actions, the method may include, as a third operation 1208, activating stimuli corresponding to the detected rule-based action 1208. In the training phase 1200, stimuli may be activated whether or not the driver is performing the rule-based action in response to a rule situation. The goal of the training phase 1200 is to form an association in the driver's mind between the stimuli and the rule-based action. The goal is not to indicate the appropriateness of the action as a response to a rule situation.

The assigned stimuli corresponding to the rule-based action may take many forms. In an embodiment, the assigned stimuli may take the form of visual feedback. Visual feedback may be presented on the HUD, dashboard, a-pillars, or some other appropriate location in or on the vehicle. Visual feedback may include LED indicators. Visual feedback comprising assigned stimuli may have selected, unified characteristics. For example, visual feedback may be a particular color. It may be a particular shape such as, for example, an arrow. It may be of a particular brightness. It may be a particular flash pattern. Other types of visual feedback are also possible.

In an embodiment, the assigned stimuli may take the form of tactile feedback delivered through the seat of the vehicle. Tactile feedback may include haptic and/or kinesthetic feedback. For example, haptic feedback may include vibration of the seat. Kinesthetic feedback may involve feedback that changes the position and/or orientation of the driver's body or body parts. For example if a driver is sitting in the seat and the seat moves, the driver's body will also move which may offer a source of kinesthetic feedback.

As a fourth operation 1210, the method may store data relating to the vehicle's surroundings and the rule-based action. Storing related data may assist in refining and strengthening the training method.

The operations of the training phase 1200 may repeat to aid the driver in forming an association between identified rule-based actions and assigned stimuli corresponding to each rule-based action. For example, the second 1206 and third 1208 operations may repeat each time a driver performs a rule-based action to build the association. The training phase 1200 may run for a set period of time. The training phase may also continue indefinitely. The training phase may also repeat periodically at selected intervals.

After the training phase 1200 has run for at least a period sufficient for a driver to form an association between rule-based actions and their assigned stimuli, the suggestion phase 1202 may begin. As a first operation 1212 of the suggestion phase, the method may include identifying a set of rule situations in which suggestion would be valuable. For example, scenarios may include a stop sign ahead a posted speed limit, and other rule situations.

As a second operation 1214 of the suggestion phase 1202, the method may include determining whether a current driving scenario matches one of the identified rule-based scenarios. This determination may be performed by leveraging the sensors, vehicle systems, and suggestion mode detection/activation circuit described above with reference to FIG. 3. For example, a current driving situation may be a situation in which a vehicle is approaching a stop sign. Sensor may detect the stop sign ahead, for example. Therefore, the current driving situation likely matches a rule-based scenario. Other examples are also possible.

If the current driving scenario does not match a rule-based scenario, the method may include continuing to monitor the current driving scenario for a match. If the current driving scenario does in fact match one of the identified rule-based scenarios, then, as a third operation 1216, the method may include identifying a rule-based action warranted by the rule-based scenario 1216. For instance, in the above example the current driving scenario was one in which the driver was approaching a stop sign. A rule-based action warranted by the stop sign would be to bring the vehicle to a stop. The warranted rule-based action, stopping, for example, may correspond to assigned stimuli. The driver may have formed an association between the rule-based action and assigned stimuli during the training phase 1200. Now during the suggestion phase, as a fourth operation 1218, the method may include activating the stimuli corresponding to the rule-based action. In the suggestion phase 1202, activating the stimuli serves as a trigger/prompt to suggest that the driver take the warranted maneuver.

As a fifth operation 1220, the method may include determining whether the driver performed the suggested rule-based action. This determination may be performed by leveraging the sensors, vehicle systems, and suggestion mode detection/activation circuit described above with reference to FIG. 3. For example, vehicle sensors may confirm that the driver did in fact stop. If the driver does in fact perform the suggested rule-based action, the method may, as a sixth operation 1222, record the fact that the driver performed the rule-based action as suggested. As a seventh operation 1224, the method may including storing data relating to the vehicle's surroundings and rule-based action. If a driver performs the rule-based action, this may provide an indication that the action was appropriate and/or warranted. Recording that the driver performed the action and storing related data may assist in refining and strengthening the method.

If a driver chooses to override the suggested rule-based action, the method may, as an alternative sixth operation 1226, record an indication that the driver has overridden the suggested rule-based action. As an alternative seventh operation 1228, the method may include storing data relating to the vehicle's surroundings and driver override. Driver override may provide an indication that the maneuver was not appropriate and/or warranted. Recording the override and storing related data may assist in refining and strengthening the method.

### Navigation Embodiment

In an embodiment, the systems and methods disclosed herein may be implemented to improve navigation. A navigation action may include any action which a would be useful for a driver to take in a navigation context. For example, a navigation action may include turning, merging onto the freeway, making a lane change, exiting the freeway, making a u-turn, and any other action that a driver may take as indicated by navigation instructions guiding a driver to a destination.

If a driver performs a navigation action often, a driver may by trained to form an association between that action and assigned stimuli. For example, a driver may merge onto the freeway every day during their commute. Therefore, merging may be a navigation action for which a driver may be trained to form an association. Other navigation actions performed often may also be good candidates for training.

Though drivers perform navigation actions often during regular driving, drivers may benefit from prompting when the need to perform the maneuvers to follow a route which they are not familiar with. Therefore, drivers may benefit from prompting to ensure drivers successfully follow navigation instructions.

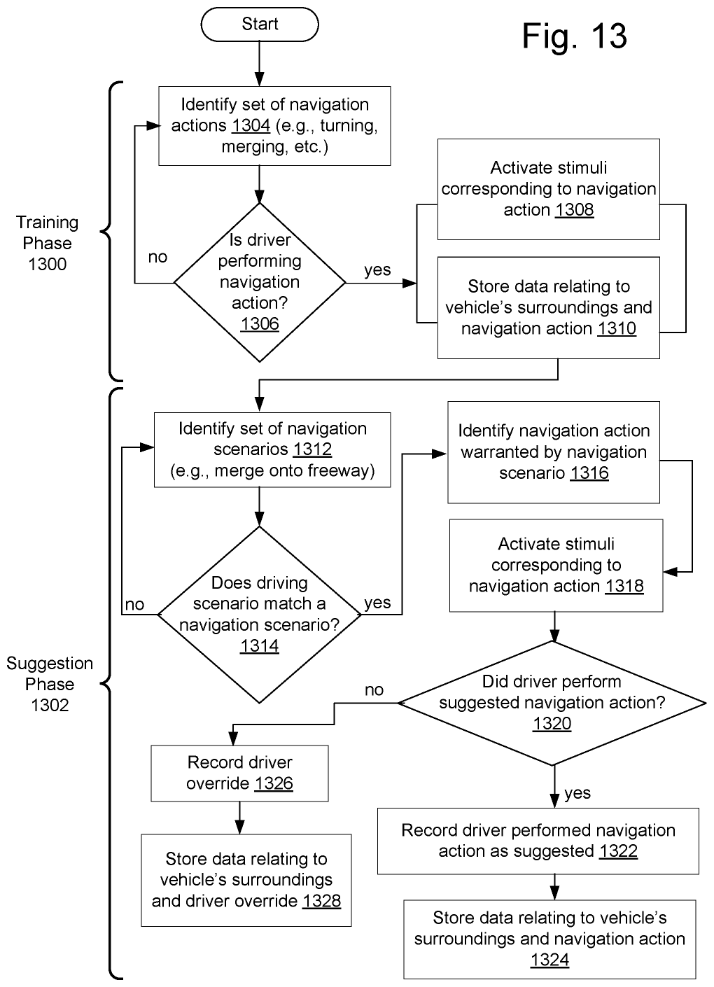

FIG. 13 is a flow diagram showing an example of a training and suggestion method for navigation actions in accordance with the systems and methods disclosed herein. A training and suggestion method for navigation actions may include two phases. The two phases may be a training phase 1300 and a suggestion phase 1302. Though the two phases are separate, they may occur concurrently in an embodiment. For example, the training phase 1300 may continue to occur while the suggestion phase 1302 is occurring. The suggestion phase 1302, however, cannot occur until the training phase 1300 has occurred for at least some period of time.

During the training phase 1300, a first operation 1304 may include identifying a set of navigation actions. The identified navigation actions may be actions that a driver would naturally perform while following navigation instructions, as discussed above. The identified navigation actions may also be actions that a driver performs frequently such that an association between a navigation action and stimuli may be conditioned. The identified navigation actions may also be actions that may benefit from suggestion to achieve successful navigation.

As a second operation 1306 during the training phase, the method may determine whether a driver is performing a navigation action. The system may determine whether a driver is performing a navigation action leveraging the sensors, vehicle systems, and training mode detection/activation circuit discussed above with reference to FIG. 2. If a driver is not performing a navigation action, the method may include continuing to monitor for a navigation action. If a driver is in fact performing one of the identified navigation actions, the method may include, as a third operation 1308, activating stimuli corresponding to the detected navigation action 1308. In the training phase 1300, stimuli may be activated whether or not the driver is performing the navigation action while following navigation instructions. The goal of the training phase 1300 is to form an association in the driver's mind between the stimuli and the navigation action. The goal is not to indicate the appropriateness of the action in following navigation instructions.

The assigned stimuli corresponding to the navigation action may take many forms. In an embodiment, the assigned stimuli may take the form of visual feedback. Visual feedback may be presented on the HUD, dashboard, a-pillars, or some other appropriate location in or on the vehicle. Visual feedback may include LED indicators. Visual feedback comprising assigned stimuli may have selected, unified characteristics. For example, visual feedback may be a particular color. It may be a particular shape such as, for example, an arrow. It may be of a particular brightness. It may be a particular flash pattern. Other types of visual feedback are also possible.

In an embodiment, the assigned stimuli may take the form of either visual and/or tactile feedback. The feedback may be delivered on or through the steering wheel of the vehicle. For example visual feedback may include a visual display on the steering wheel, such as, illumination of the steering wheel. Tactile feedback may include haptic and/or kinesthetic feedback. For example, haptic feedback may include vibration of the steering wheel. Kinesthetic feedback may involve feedback that changes the position and/or orientation of the driver's body or body parts. For example if a driver is grasping a steering wheel and the steering wheel moves, the driver's hands/arms will also move which may offer a source of kinesthetic feedback.

In an embodiment, the assigned stimuli may take the form of tactile feedback delivered through the seat of the vehicle. Tactile feedback may include haptic and/or kinesthetic feedback. For example, haptic feedback may include vibration of the seat. Kinesthetic feedback may involve feedback that changes the position and/or orientation of the driver's body or body parts. For example if a driver is sitting in the seat and the seat moves, the driver's body will also move which may offer a source of kinesthetic feedback.

As a fourth operation 1310, the method may store data relating to the vehicle's surroundings and the navigation action. Storing related data may assist in refining and strengthening the training method.

The operations of the training phase 1300 may repeat to aid the driver in forming an association between identified navigation actions and assigned stimuli corresponding to each navigation action. For example, the second 1306 and third 1308 operations may repeat each time a driver performs a navigation action to build the association. The training phase 1300 may run for a set period of time. The training phase may also continue indefinitely. The training phase may also repeat periodically at selected intervals.

After the training phase 1300 has run for at least a period sufficient for a driver to form an association between navigation actions and their assigned stimuli, the suggestion phase 1302 may begin. As a first operation 1312 of the suggestion phase, the method may include identifying a set of navigation scenarios in which suggestion would be valuable. For example, scenarios may include performing a turn and/or performing a lane change.

As a second operation 1314 of the suggestion phase 1302, the method may include determining whether a current driving scenario matches one of the identified navigation scenarios. This determination may be performed by leveraging the sensors, vehicle systems, and suggestion mode detection/activation circuit described above with reference to FIG. 3. For example, a current driving situation may be a situation in which a driver is following instructions to reach a set destination. To stay on route, the driver may need to turn. Vehicle data including GPS data may provide the driver's location relative to the set destination. A situation in which a driver must turn to stay on route matches a navigation scenario. Other examples are also possible.

If the current driving scenario does not match a navigation scenario, the method may include continuing to monitor the current driving scenario for a match. If the current driving scenario does in fact match one of the identified navigation scenarios, then, as a third operation 1316, the method may include identifying a navigation action warranted by the navigation scenario 1316. For instance, in the above example the current driving scenario was one in which a driver needed to turn to stay on route. A navigation action warranted by that scenario would be turning. The warranted navigation action, turning, for example, may corresponding to assigned stimuli. The driver may have formed an association between the navigation action and assigned stimuli in during the training phase 1300. Now during the suggestion phase, as a fourth operation 1318, the method may include activating the stimuli corresponding to the navigation action. In the suggestion phase 1302, activating the stimuli serves as a trigger/prompt to suggest that the driver take the warranted maneuver.

As a fifth operation 1320, the method may include determining whether the driver performed the suggested navigation action. This determination may be performed by leveraging the sensors, vehicle systems, and suggestion mode detection/activation circuit described above with reference to FIG. 3. For example, vehicle sensors may confirm that the driver did in fact activate turn. If the driver does in fact perform the suggested navigation action, the method may, as a sixth operation 1322, record the fact that the driver performed the navigation action as suggested. As a seventh operation 1324, the method may including storing data relating to the vehicle's surroundings and navigation action. If a driver performs the navigation action, this may provide an indication that the action was appropriate and/or warranted. Recording that the driver performed the action and storing related data may assist in refining and strengthening the method.

If a driver chooses to override the suggested navigation action, the method may, as an alternative sixth operation 1326, record an indication that the driver has overridden the suggested navigation action. As an alternative seventh operation 1328, the method may include storing data relating to the vehicle's surroundings and driver override. Driver override may provide an indication that the maneuver was not appropriate and/or warranted. Recording the override and storing related data may assist in refining and strengthening the method.

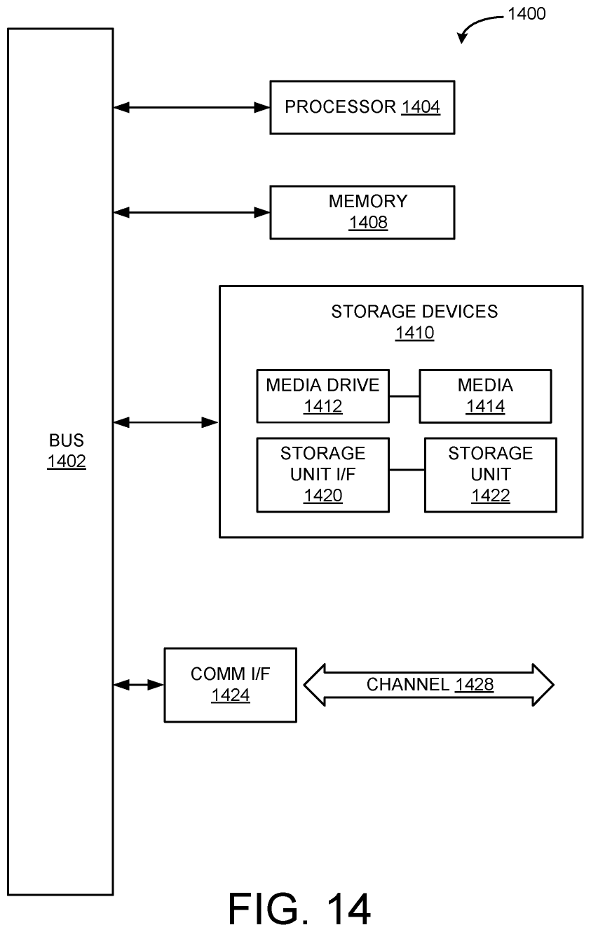

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 14. Various embodiments are described in terms of this example-computing component 1400. After reading this description, it will become apparent to a person skilled in the relevant art how to implement the application using other computing components or architectures.

Referring now to FIG. 14, computing component 1400 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1400 might also represent computing capabilities embedded within or otherwise available to a given device. For example, a computing component might be found in other electronic devices such as, for example, portable computing devices, and other electronic devices that might include some form of processing capability.

Computing component 1400 might include, for example, one or more processors, controllers, control components, or other processing devices. This can include a processor, and/or any one or more of the components making up a user device, user system, and non-decrypting cloud service. Processor 1404 might be implemented using a general-purpose or special-purpose processing engine such as, for example, a microprocessor, controller, or other control logic. Processor 1404 may be connected to a bus 1402. However, any communication medium can be used to facilitate interaction with other components of computing component 1400 or to communicate externally.

Computing component 1400 might also include one or more memory components, simply referred to herein as main memory 1408. For example, random access memory (RAM) or other dynamic memory, might be used for storing information and instructions to be executed by processor 1404. Main memory 1408 might also be used for storing temporary variables or other intermediate information during execution of instructions to be executed by processor 1404. Computing component 1400 might likewise include a read only memory (“ROM”) or other static storage device coupled to bus 502 for storing static information and instructions for processor 1404.

The computing component 1400 might also include one or more various forms of information storage mechanism 1410, which might include, for example, a media drive 1412 and a storage unit interface 1420. The media drive 1412 might include a drive or other mechanism to support fixed or removable storage media 1414. For example, a hard disk drive, a solid-state drive, a magnetic tape drive, an optical drive, a compact disc (CD) or digital video disc (DVD) drive (R or RW), or other removable or fixed media drive might be provided. Storage media 1414 might include, for example, a hard disk, an integrated circuit assembly, magnetic tape, cartridge, optical disk, a CD or DVD. Storage media 1414 may be any other fixed or removable medium that is read by, written to or accessed by media drive 1412. As these examples illustrate, the storage media 1414 can include a computer usable storage medium having stored therein computer software or data.

In alternative embodiments, information storage mechanism 1410 might include other similar instrumentalities for allowing computer programs or other instructions or data to be loaded into computing component 1400. Such instrumentalities might include, for example, a fixed or removable storage unit 1422 and an interface 1420. Examples of such storage units 1422 and interfaces 1420 can include a program cartridge and cartridge interface, a removable memory (for example, a flash memory or other removable memory component) and memory slot. Other examples may include a PCMCIA slot and card, and other fixed or removable storage units 1422 and interfaces 520 that allow software and data to be transferred from storage unit 1422 to computing component 500.

Computing component 1400 might also include a communications interface 1424. Communications interface 1424 might be used to allow software and data to be transferred between computing component 1400 and external devices. Examples of communications interface 1424 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1424 may be carried on signals, which can be electronic, electromagnetic (which includes optical) or other signals capable of being exchanged by a given communications interface 1424. These signals might be provided to communications interface 1424 via a channel 1428. Channel 1428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1408, storage unit 1420, media 1414, and channel 1428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1400 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A training system comprising:
a sensor array comprising sensors configured to detect vehicle maneuvers performed by a driver;
a human-machine interface (“HMI”) configured to present stimuli to a driver; and
a training circuit communicably coupled to the sensor array and HMI and configured to:
assign corresponding stimuli to a set of vehicle maneuvers;
detect a vehicle maneuver of the set of vehicle maneuvers using the sensor array; and
while the detected vehicle maneuver is occurring, present the assigned stimuli using the HMI.

2. The system of claim 1 wherein the stimuli comprises visual stimuli.

3. The system of claim 2 wherein the stimuli comprises visual stimuli delivered on a HUD.

4. The system of claim 2 wherein the stimuli comprises visual stimuli delivered on a dashboard.

5. The system of claim 2 wherein the stimuli comprises visual stimuli delivered on a-pillars.

6. The system of claim 2 wherein the stimuli comprises visual stimuli delivered on a steering wheel.

7. The system of claim 1 wherein the stimuli comprises tactile stimuli.

8. The system of claim 7 wherein the stimuli comprises tactile stimuli delivered through a driver's seat.

9. The system of claim 7 wherein the stimuli comprises tactile stimuli delivered through the steering wheel.

10. The system of claim 7 wherein the stimuli comprises tactile stimuli delivered through pedals.

11. A suggestion system comprising:
a sensor array comprising sensors configured to detect driving scenarios;
a human-machine interface (“HMI”) configured to present stimuli to a driver; and
a suggestion circuit communicably coupled to the sensor array and HMI and configured to:
detect a driving scenario using the sensor array;
identify a desired maneuver corresponding to the detected driving scenario;
receive an indication of assigned stimuli corresponding to the desired maneuver; and
present the assigned stimuli using the HMI to suggest the desired maneuver to a driver.

12. The system of claim 11 wherein the driving scenario is a scenario warranting a communication action.

13. The system of claim 11 wherein the driving scenario is a scenario warranting a longitudinal control action.

14. The system of claim 11 wherein the driving scenario is a scenario warranting a lateral control action.

15. The system of claim 11 wherein the driving scenario is a scenario risk scenario.

16. The system of claim 11 wherein the driving scenario is a rule scenario.

17. The system of claim 11 wherein the driving scenario is a navigation scenario.

18. An improved driving prompt method comprising:
assigning stimuli to a set of vehicle maneuvers;
detecting initiation of a vehicle maneuver of the set of vehicle maneuvers;
presenting the stimuli corresponding to the detected maneuver while a driver continues to perform the detected maneuver;
repeating the detecting and presenting operations to create an association between the maneuver and the stimuli in the driver's mind;
detecting a current driving scenario for the area in which a driver is operating a vehicle;
identifying a desired vehicle maneuver warranted by the driving scenario for the area in which the driver is operating the vehicle;
receiving an indication of assigned stimuli corresponding to the desired vehicle maneuver; and
presenting the corresponding stimuli to suggest the desired vehicle maneuver to the driver.

19. The system of claim 18 further comprising:
detecting that the driver performed the suggested vehicle maneuver;
recording the fact that the driver performed the suggested maneuver; and
storing data related to the vehicle's surroundings and the performed maneuver.

20. The system of claim 18 further comprising:
detecting that the driver did not perform the suggested vehicle maneuver;
recording the fact that the driver did not perform the suggested maneuver; and
storing data related to the vehicle's surroundings and any maneuvers performed by the driver.
